(19) United States
(12) Patent Application Publication
(10) Pub. No.: US 2026/0266241 A1
(43) Pub. Date: Sep. 10, 2026

(54) MODULE FOR PROJECTILE

(71) Applicant: ISRAEL AEROSPACE INDUSTRIES LTD., Lod (IL)

(72) Inventor: Boaz ZUSSMAN, Lod (IL)

(21) Appl. No.: 19/163,613

(22) PCT Filed: Mar. 14, 2024
(86) PCT No.: PCT/IL2024/050276

§ 371 Date: Sep. 9, 2025

(30) Foreign Application Priority Data
Mar. 15, 2023 (IL) 301400

(51) Int. Cl. F02K 9/88; F02K 9/42; F42B 10/14; F42B 15/36

(52) U.S. Cl. CPC F02K 9/88; F02K 9/42; F42B 10/14; F42B 15/36

(57) ABSTRACT

An ejection module for ejecting a projectile includes a module forward end and a module aft end. The module forward end includes a central axis, and a module interface configured for selectively affixing the module to the projectile in a load-bearing manner, and for enabling selective disconnection between the module and the projectile. The module aft end includes a module propulsion system having a plurality of rocket motors and rocket propellant source. Each rocket motor: is laterally spaced with respect to the central axis; has a respective fixed thrust vector non-parallel with respect to the central axis; and is configured for generating a controllable level of respective thrust along the respective thrust vector, independently of the respective level of thrust generated by the other rocket motors along their respective thrust vectors. The module propulsion system is configured for enabling independently controlling the respective level of thrust of each rocket motor.

### TECHNOLOGICAL FIELD

The presently disclosed subject matter relates to systems, methods and accessories for launching projectiles, in particular for launching projectiles from a launch tube.

### BACKGROUND

Vertical launch systems (VLS) for launching missiles are well known in the art. Conventionally, VLS include at least two different categories: hot launches and cold launches.

In a conventional hot launch VLS, the missile propulsion system is ignited in the launch tube at launch, and the missile propels itself out of the cell or firing tube, and thereafter continues along its trajectory still under power from the missile propulsion system for at least a time period after launch.

In cold launch VLS the missile is conventionally ejected from the cell or launch tube via gas produced by a gas generator, which is not necessarily part of the missile.

Hot launch VLS are conventionally considered advantageous in that no separate ejection system is required for launch, while a major disadvantage of such systems is that a malfunction in the missile propulsion system can destroy the launch tube and possibly also the immediate area around the launch tube.

On the other hand, cold launch VLS, while conventionally more complex than hot launch VLS, provide greater safety, as a malfunctioning missile is effectively ejected out of the launch tube and the threat of such a missile damaging the launch tube or immediate area is much reduced. Some surface to air missiles (SAM) and ship launched missiles are cold launched.

Many types of missiles are known in the art.

By way of non-limiting example, U.S. Pat. No. 10,378,483 discloses a motor assembly for use with projectiles, such as munitions, having relatively low length to diameter ratios. The motor assembly has an aerospike nozzle and a casing disposed about the aerospike nozzle, where interior aerospike volume contains propellant and where walls of both the cowl of the casing and of the aerospike nozzle jointly define a combustion chamber.

Also by way of non-limiting example, U.S. Pat. No. 9,534,563 discloses a projectile for firing from a launcher, including a propulsion stage having non-axisymmetric boosters arranged about a longitudinal axis of the propulsion stage. The propulsion stage may further include a central booster about which the non-axisymmetric boosters are arranged.

Also by way of non-limiting example, U.S. Pat. No. 7,108,223 discloses a jet propulsion outlet device that has a grid plate having a plurality of densely clustered nozzlettes, the nozzlettes of the grid plate being configured to operably couple to a pressurized gas source to efficiently expand the pressurized gas.

Also by way of non-limiting example, U.S. Pat. No. 5,615,847 discloses a submarine launched unmanned aerial vehicle comprises an elongated generally cylindrically-shaped body. Tail fins are stored in the body and are self-deployable to extend outwardly from the body. A booster motor is fixed to an aft end of the body and is self-releasable from the body. A propeller is disposed at the aft end of the body and is self-deployable to an exposed position at the aft end of the body after release of the booster motor. A propulsion motor is mounted in the body and is operative to drive the propeller. Rotors are stored in the body and are self-deployable to an exposed position wherein the rotors provide lift to the vehicle.

Also by way of non-limiting example, U.S. Pat. No. 4,364,530 discloses a modular, apogee-control package which can be added to existing missiles, and which will limit the apogee of the missile trajectory by implementation of thrust vector control (TVC). The package comprises a boost guidance unit, a solid rocket propellant motor, and jet vane TVC.

### General Description

According to a first aspect of the presently disclosed subject matter there is provided an ejection module for a projectile, in particular for ejecting a projectile, the module comprising:
a module forward end comprising a central axis and a module interface, the module interface configured for selectively enabling, in particular for selectively causing the module to be selectively affixed to the projectile in a load-bearing manner, and for selective disconnection between the module and the projectile; and
a module aft end comprising a module propulsion system, the module propulsion system comprising a plurality of rocket motors and a source of rocket propellant, wherein:
   each said rocket motor is laterally spaced with respect to the central axis,
   each said rocket motor has a respective fixed thrust vector non-parallel with respect to the central axis,
   each said rocket motor is configured for generating a controllable level of respective thrust along the respective said thrust vector, independently of the respective level of thrust generated by the other said rocket motors along their respective thrust vectors;
wherein the module propulsion system is configured for enabling independently controlling the respective said level of thrust of each said rocket motor, i.e., wherein the module propulsion system is configured for enabling the independent control of the respective said level of thrust of each said rocket motor.

For example, said source of rocket propellant includes a predetermined quantity of propellant not greater than that required to enable the module to propel the projectile from a launch site to a predetermined range and predetermined altitude with respect to the launch site, wherein said predetermined range and said predetermined altitude correspond to a minimum safe range and a minimum safe altitude with respect to the launch site.

For example, said minimum safe range and said minimum safe altitude ensures or minimizes potential damage to the launch site in event of the projectile failing to operate after disconnection from the ejection module and falls back to Earth under gravity.

Additionally or alternatively for example, said predetermined safe range is between 50 m and about 70 m, and/or the range does not exceed 100 m, and/or the range does not exceed 500 m.

Additionally or alternatively for example, said predetermined safe altitude is between about 30 m and about 20 m, and/or said predetermined safe does not exceed about 100 m.

Additionally or alternatively for example, the ejection module is configured for providing any desired tilt after launch at least between 90° and 0° in elevation, or for example in the range −20° to 80°, or for example from 0° to 40°, or for example from 20° to 30°, for example depending in the specific mission parameters.

Additionally or alternatively for example, the ejection module is configured for providing any desired azimuth after launch at least between 0° and 360°.

Additionally or alternatively for example, each said thrust vector converges towards the central axis at a respective intersection point aft of the module aft end. For example, the respective intersection points of the thrust vectors are the same point.

Additionally or alternatively for example, each said thrust vector lies on a respective plane, and wherein said central axis lies on each said plane. For example, each said thrust vector defines a respective thrust angle on the respective plane with respect to the central axis. For example, the respective thrust angles of said rocket motors are equal in magnitude to one another. Additionally or alternatively for example, each said thrust angle is in the range of between about 10° and about 30°, or for example each said thrust angle is in the range of between about 15° and about 20°, or for example each said thrust angle is about 17°.

Additionally or alternatively for example, said rocket motors are configured as liquid fuel rocket motors, and wherein said source of rocket propellant includes at least one liquid fuel tank and at least one oxidizer tank. In at least some other examples the rocket motors can be provided with any suitable propellants that allow for control of the level of respective thrust generated by the rocket motor.

Additionally or alternatively for example, the ejection module is configured for providing a forward velocity to the projectile at least sufficient to enable the projectile to steer, for example to steer aerodynamically, for example via fins, or in any other suitable manner.

Additionally or alternatively for example, the ejection module is configured for providing a forward velocity to the projectile sufficient to enable the projectile to initiate and maintain flight under its own power.

Additionally or alternatively for example, the ejection module is configured for providing a forward velocity to the projectile at least greater than 20 m/s, or at least greater than 20 m/s and for example up to 40 m/s, or wherein the forward speed can be in the range 20 m/s to 50 m/s.

Additionally or alternatively for example, the ejection module further comprises a control unit operatively coupled to the module propulsion system, the control unit being configured for enabling independently controlling the respective said level of thrust of each said rocket motor. For example, the control unit is accommodated in the ejection module. Alternatively for example, the control unit is accommodated in the projectile.

Additionally or alternatively for example, said control unit is configured for operating the module to provide sufficient thrust to launch the projectile.

Additionally or alternatively for example, said control unit is configured for operating the module propulsion system such that the plurality of said rocket motors provide equal thrust to enable the module to provide a net thrust co-axial with the central axis.

Additionally or alternatively for example, said control unit is configured for operating the module propulsion system to provide any desired tilt maneuver. For example, said control unit is configured for operating the module propulsion system such that at least one said rocket motor generates less thrust than at least one other said rocket motor.

Additionally or alternatively for example, said module propulsion system comprises a first said rocket motor, a second said rocket motor and a third said rocket motor, wherein said first rocket motor, said second rocket motor and said third rocket motor are uniformly spaced circumferentially with respect to the central axis. For example, each said rocket motor comprises a respective exhaust nozzle fixedly mounted to the rocket motor in alignment with the respective said thrust vector. Additionally or alternatively for example, the control unit is configured for operating the module propulsion system such that the first rocket motor generates a first said thrust, the second rocket motor concurrently generates a second said thrust, and the third rocket motor concurrently generates a third said thrust, such that the first thrust, the second thrust and the third thrust together provide a module net thrust and a corresponding module thrust vector.

For example, the ejection module is operable for selectively causing the module to execute a first acceleration maneuver, wherein said first thrust, said second thrust and said third thrust are equal to one another. For example, said control unit is configured for selectively causing the module to execute a first acceleration maneuver, wherein said first thrust, said second thrust and said third thrust are equal to one another.

For example, the ejection module is operable for selectively causing the module to execute a first tilt maneuver, wherein said first thrust is greater than said second thrust or said third thrust, and wherein said second thrust is equal to said third thrust. For example, said control unit is configured for selectively causing the module to execute a first tilt maneuver, wherein said first thrust is greater than said second thrust or said third thrust, and wherein said second thrust is equal to said third thrust.

For example, said first thrust corresponds to a nominal maximum thrust level for the said first rocket motor, and wherein said second thrust and said third thrust are each nominally zero.

For example, the ejection module is operable for executing said first tilt maneuver for a first time period, and for subsequently implementing a first righting maneuver for a second time period wherein for said second time period the said first thrust is less than said second thrust or said third thrust, and wherein said second thrust is equal to said third thrust, followed by implementing a second righting maneuver for a third time period, wherein for said third time period said first thrust, said second thrust and said third thrust are equal to one another. For example, the control unit is configured for executing said first tilt maneuver for a first time period, and for subsequently implementing a first righting maneuver for a second time period wherein for said second time period the said first thrust is less than said second thrust or said third thrust, and wherein said second thrust is equal to said third thrust, followed by implementing a second righting maneuver for a third time period, wherein for said third time period said first thrust, said second thrust and said third thrust are equal to one another.

For example, the ejection module is operable for enabling, in particular for selectively causing the module to execute a second tilt maneuver, wherein said first thrust is less than said second thrust or said third thrust, and wherein said second thrust is equal to said third thrust. For example, the control unit is configured for enabling, in particular for selectively causing the module to execute a second tilt maneuver, wherein said first thrust is less than said second thrust or said third thrust, and wherein said second thrust is equal to said third thrust.

For example, the ejection module is operable for enabling, in particular for selectively causing the module to execute a third tilt maneuver, wherein said first thrust is greater than said second thrust or said third thrust, and wherein said second thrust is greater than said third thrust. For example, said control unit is configured for enabling, in particular for selectively causing the module to execute a third tilt maneuver, wherein said first thrust is greater than said second thrust or said third thrust, and wherein said second thrust is greater than said third thrust.

For example, said first thrust corresponds to a nominal maximum thrust level for the said first rocket motor, and wherein said third thrust is nominally zero, and wherein said second thrust is intermediate in magnitude between said first thrust and said third thrust. Additionally or alternatively for example, the control unit is configured for executing said third tilt maneuver for a first time period, and for subsequently implementing a first righting maneuver for a second time period wherein for said second time period said first thrust, said second thrust and said third thrust are each nominally zero, followed by implementing a second righting maneuver for a third time period, wherein for said third time period said third thrust is greater than said second thrust, and said second thrust is greater than said first thrust, followed by implementing a third righting maneuver for a fourth time period, wherein for said fourth time period said first thrust, said second thrust and said third thrust are equal to one another.

For example, the ejection module is operable for enabling, in particular for selectively causing the module to execute a third tilt maneuver, wherein said first thrust is greater than said second thrust or said third thrust, and wherein said second thrust is less than said third thrust. For example, the control unit is configured for enabling, in particular for selectively causing the module to execute a third tilt maneuver, wherein said first thrust is greater than said second thrust or said third thrust, and wherein said second thrust is less than said third thrust.

Additionally or alternatively for example, said third tilt maneuver is configured to provide a desired change in azimuth during execution of said third tilt maneuver.

According to a second aspect of the presently disclosed subject matter there is provided a projectile assembly, comprising:
a projectile having a projectile propulsion system and an aft projectile end, the aft projectile end comprising a projectile interface;
an ejection module as defined herein regarding the first aspect of the presently disclosed subject matter;
wherein the projectile interface is configured for being selectively and reversibly coupled with respect to the module interface, such that when thus coupled the module is reversibly affixed to the projectile in a load-bearing manner, and such that when the projectile interface is decoupled with respect to the module interface, the module is disconnected from the projectile.

For example, the projectile comprises a plurality of fins. In at least some other examples, the projectile omits fins, and for example can be stabilized in any suitable manner.

According to a third aspect of the presently disclosed subject matter there is provided a launch system comprising:
a projectile assembly as defined herein regarding the second aspect of the presently disclosed subject matter;
a launch tube configured for accommodating the projectile launch assembly therein at least in a launch-ready configuration, and for enabling, in particular for selectively causing selective launch of the projectile launch assembly from the launch tube.

For example, in at least some examples, said launch tube has a closed bottom end, while in at least some other examples, said launch tube has an open bottom end.

For example, said launch tube has a closed bottom end, and wherein said launch tube includes an excess pressure venting arrangement configured for enabling venting of the launch tube responsive to a pressure within the launch tube exceeding a predetermined threshold pressure.

For example, said launch tube comprises a launch tube casing, the launch tube comprising at least one venting opening, and wherein said excess pressure venting arrangement comprises at least one burst disc provided in each said venting opening, wherein each said disc is configured for bursting when subjected to a pressure exceeding said predetermined threshold pressure.

According to a third aspect of the presently disclosed subject matter there is provided a method for launching a projectile, comprising;
(a) providing a launch system as defined herein regarding the third aspect of the presently disclosed subject matter;
(b) selectively launching the projectile launch assembly from the launch tube by operating the module propulsion system to generate thrust sufficient to at least eject the projectile launch assembly outside of a control zone around the launch tube;
(c) decoupling the module from the projectile according to predetermined criteria including a first criterion, wherein said first criterion requires the projectile launch assembly to be outside of said control zone.

For example, at least during step (b) the projectile propulsion system is not operated.

Additionally or alternatively, for example, the ejection module is as defined herein regarding the first aspect of the presently disclosed subject matter, and the module propulsion system is operated such that the first rocket motor generates a first said thrust, the second rocket motor concurrently generates a second said thrust, and the third rocket motor concurrently generates a third said thrust, such that the first thrust, the second thrust and the third thrust together provide a module net thrust and a corresponding module thrust vector.

For example, said first thrust, said second thrust and said third thrust are equal to one another.

For example, the module executes a first tilt maneuver, wherein said first thrust is greater than said second thrust or said third thrust, and wherein said second thrust is equal to said third thrust. For example, said first thrust corresponds to a nominal maximum thrust level for the said first rocket motor, and wherein said second thrust and said third thrust are each nominally zero.

For example, said first tilt maneuver is executed for a first time period, and the method further comprises;
(I) subsequently implementing a first righting maneuver for a second time period wherein for said second time period the said first thrust is less than said second thrust or said third thrust, and wherein said second thrust is equal to said third thrust,
(II) subsequent to step (I) implementing a second righting maneuver for a third time period, wherein for said third time period said first thrust, said second thrust and said third thrust are equal to one another.

For example, the module executes a second tilt maneuver, wherein said first thrust is less than said second thrust or said third thrust, and wherein said second thrust is equal to said third thrust.

For example, the module executes a third tilt maneuver, wherein said first thrust is greater than said second thrust or said third thrust, and wherein said second thrust is greater than said third thrust. For example, said first thrust corresponds to a nominal maximum thrust level for the said first rocket motor, and wherein said third thrust is nominally zero, and wherein said second thrust is intermediate in magnitude between said first thrust and said third thrust. Additionally or alternatively, for example, the third tilt maneuver is executed for a first time period, and the method further comprises:
(i) subsequently implementing a first righting maneuver for a second time period wherein for said second time period said first thrust, said second thrust and said third thrust are each nominally zero,
(ii) subsequent to step (i), implementing a second righting maneuver for a third time period, wherein for said third time period said third thrust is greater than said second thrust, and said second thrust is greater than said first thrust,
(iii) subsequent to step (ii), implementing a third righting maneuver for a fourth time period, wherein for said fourth time period said first thrust, said second thrust and said third thrust are equal to one another.

For example, said control unit is configured for enabling, in particular for selectively causing the module to execute a third tilt maneuver, wherein said first thrust is greater than said second thrust or said third thrust, and wherein said second thrust is less than said third thrust.

Additionally or alternatively, for example, said third tilt maneuver is configured to provide a desired change in azimuth during execution of said third tilt maneuver.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is an isometric view of an ejector module according to an example of the presently disclosed subject matter.

FIG. 2 is an isometric view of a projectile assembly including the example of the ejector module of FIG. 1, wherein the projectile assembly has just ejected from a launch tube.

FIG. 3 schematically illustrates a control zone associated with the projectile assembly example of FIG. 2.

FIG. 4 is an isometric view of a lower portion of a projectile of the projectile assembly example of FIG. 2.

FIG. 5 is an isometric cross-sectional view of a lower portion of the projectile assembly example of FIG. 2.

FIG. 6(a) is an isometric view of a lower portion of the projectile assembly example of FIG. 2, prior to separation; FIG. 6(b) is an isometric view of the example of FIG. 6(a) during separation; FIG. 6(c) is an isometric view of the example of FIG. 6(a) after separation.

FIG. 7 is an isometric exploded view of the example of FIG. 1.

FIG. 8 is a cross-sectional view of a rocket motor of the ejector module example of FIG. 1.

FIG. 9 schematically illustrates an example of a propulsion system of the ejection module example of FIG. 1.

FIG. 10 schematically illustrates geometrical relationships associated with the ejection module example of FIG. 1.

FIG. 11 schematically illustrates azimuth and elevation angles associated with the projectile assembly example of FIG. 2.

FIG. 12 schematically illustrates thrust distributions over time for one example of operation of the ejection module example of FIG. 1.

FIG. 13(a) schematically illustrates thrust levels associated with an example of operation of the ejection module example of FIG. 1 in which there is no net radial thrust;

FIG. 13(b) schematically illustrates thrust levels associated with an example of operation of the ejection module example of FIG. 1 in which there is a net radial thrust in an upward vertical direction; FIG. 13(c) schematically illustrates thrust levels associated with an example of operation of the ejection module example of FIG. 1 in which there is a net radial thrust in a downward vertical direction; FIG. 13(d) schematically illustrates thrust levels associated with an example of operation of the ejection module example of FIG. 1 in which there is no net radial thrust.

FIG. 14 schematically illustrates thrust distributions over time for another example of operation of the ejection module example of FIG. 1.

FIG. 15 schematically illustrates thrust distributions over time for another example of operation of the ejection module example of FIG. 1.

FIG. 16(a) schematically illustrates thrust levels associated with an example of operation of the ejection module example of FIG. 1 in which there is a net radial thrust in a general lateral and vertically upward direction; FIG. 16(b) schematically illustrates thrust levels associated with an example of operation of the ejection module example of FIG. 1 in which there is no net radial thrust; FIG. 16(c) schematically illustrates thrust levels associated with an example of operation of the ejection module example of FIG. 1 in which there is a net radial thrust in a general lateral and vertically downward direction; FIG. 16(d) schematically illustrates thrust levels associated with an example of operation of the ejection module example of FIG. 1 in which there is no net radial thrust.

FIG. 17 is a cross-sectional side view of a bottom portion of the projectile assembly example of FIG. 2 when accommodated in the launch tube.

FIG. 18 is a cross-sectional isometric view of a bottom portion of an alternative variation of the projectile assembly example of FIG. 2 when accommodated in the launch tube.

### DETAILED DESCRIPTION

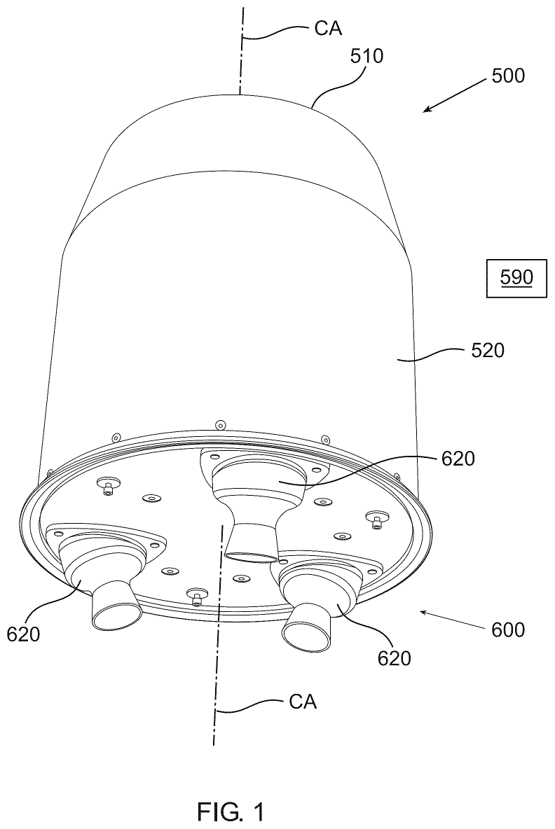

Referring to FIG. 1, an ejection module (also interchangeably referred to herein as a module) according to a first example of the presently disclosed subject matter, generally designated with reference numeral 500, comprises a module forward end 510, and a module aft end 520.

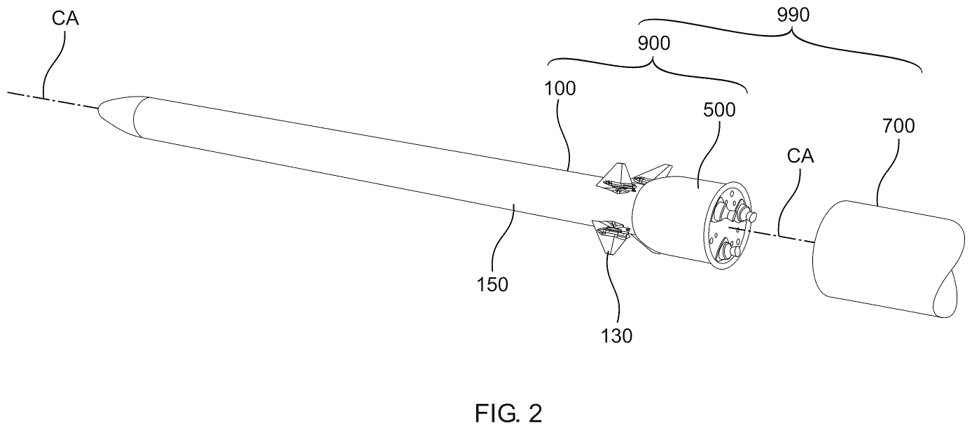

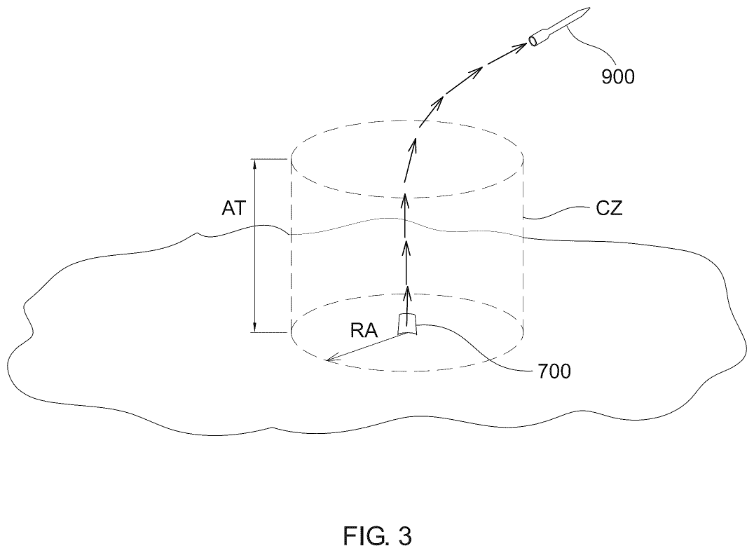

Referring to FIG. 2 and FIG. 3, the module 500 is configured for ejecting a projectile 100 out of a launch tube 700 or the like, and for propelling the projectile 100 at least out of a control zone CZ associated with the launch tube 700. The control zone CZ is defined by a control zone altitude AT and a control range RA from the launch tube 700 at launch site LS.

In particular, the module 500 is configured for enabling the ejection of a projectile 100 out of a launch tube 700 and to bring the projectile 100 to a specific position and orientation outside the launcher according to mission and safety requirements.

As will become clearer herein, when coupled together the module 500 and the projectile 100 provide a projectile assembly 900.

Also as will become clearer herein, a launch system 990 according a first example comprises at least one projectile assembly 900 and at least one launch tube 700. The launch tube 700 is configured for accommodating the projectile assembly 900 therein at least in a launch-ready configuration, and for enabling selective launch of the projectile assembly 900 from the launch tube 700.

The size of the control zone CZ, in particular the magnitude of the altitude AT and the magnitude of the range RA, correspond to, and represent, a minimum safety altitude and range, respectively, for the projectile 100 to reach, such that, in case the projectile malfunctions, there is minimal risk of damage and/or injury within the control zone CZ resulting from such malfunction.

For example, the altitude AT can be between about 30 m and about 20 m, and the range RA can be between about 50 m and about 70 m. In at least some examples, the altitude AT does not exceed about 100 m, and/or the range RA does not exceed about 100 m. In at least some examples, the range RA does not exceed about 500 m.

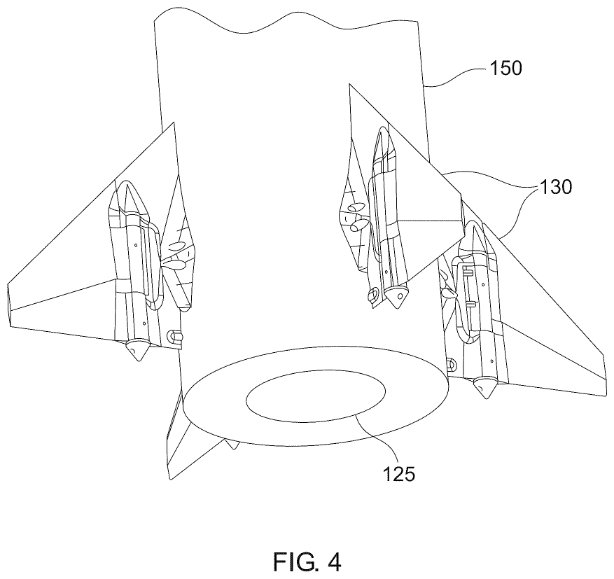

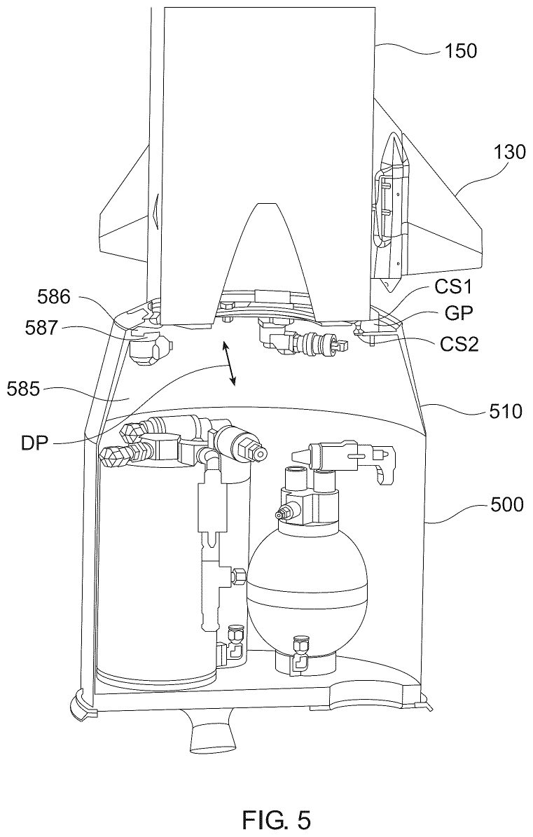

Referring also to FIG. 4 and FIG. 5, the projectile 100 can be any suitable missile or rocket, and comprises a projectile aft end 150 and a projectile propulsion system. While in at least this example the propulsion system includes one projectile rocket motor 125, in alternative variations of this example the respective propulsion system can include a plurality of projectile rocket motors. In any case the one or more projectile rocket motors can be provided with any suitable propellants.

The projectile 100 can also include a suitable payload, typically at the front end thereof, for example a warhead.

In at least this example, the projectile 100 further comprises a plurality of fins 130, which in at least this example are deployable between a stowed configuration and a deployed configuration. In the stowed configuration, the fins 130 are pivoted to a position overlying the casing of the projectile 100, as illustrated in FIG. 1, and provide a compact configuration suitable for the launch tube 700. In the deployed configuration, which does not occur until at least after the projectile 100 has fully exited the launch tube 700, the fins 130 project for example radially with respect to the projectile casing, and provide stability to the projectile in flight.

The module 500 is configured for being reversibly coupled to the projectile to form a projectile assembly 900.

Referring again to FIG. 2, the module 500 defines a central axis CA, which at least in this example is parallel to and co-axial with the longitudinal axis LA of the projectile 100, when the module 500 is coupled to the projectile 100 in the projectile assembly 900.

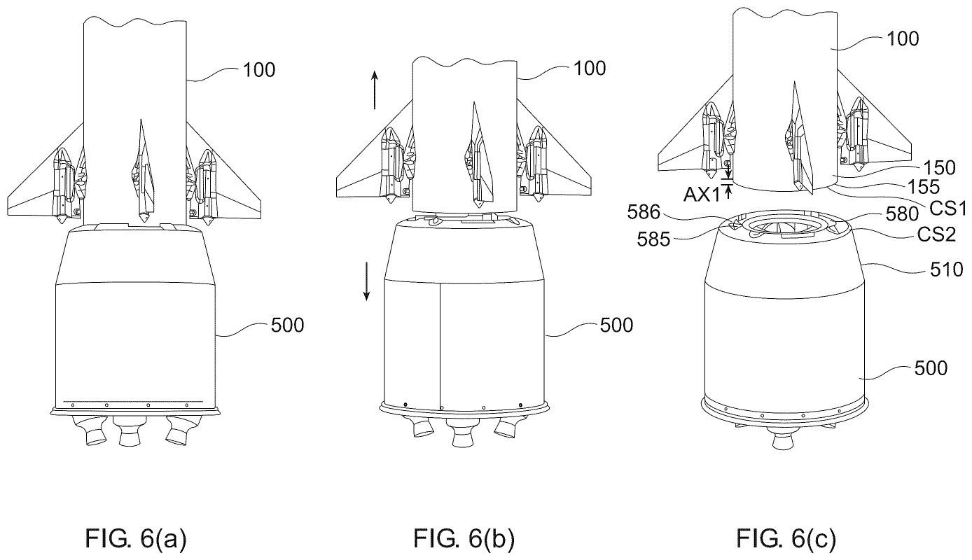

Referring also to FIG. 6(a), FIG. 6(b), and FIG. 6(c), the module forward end 510 comprises a module interface 580.

The module interface 580 is configured for selectively enabling the module 500 to be selectively affixed to the projectile 100 in a load-bearing manner, and for enabling selective disconnection between the module 500 and the projectile 100.

For example, the projectile aft end 150 comprises a projectile interface 155. The projectile interface 155 is configured for being selectively and reversibly coupled with respect to the module interface 580, such that when thus coupled the module 500 is reversibly affixed to the projectile 100 in a load-bearing manner, and such that when the projectile interface 155 is decoupled with respect to the module interface 580, the module 500 is disconnected from the projectile 100.

In at least this example, the projectile interface 155 comprises a projecting end 156 having first cross-sectional shape CS1, which is uniform for an axial length AX1 of the projecting end 156.

Referring again to FIG. 5, in at least this example, the module interface 580 comprises a forward facing well 585 having an inlet end 586 having an opening defining a second cross-sectional shape CS2 which can be essentially complementary to the first cross-sectional shape CS1, wherein the first cross-sectional shape CS1 is peripherally spaced by a suitable tolerance gap GP with respect to the second cross-sectional shape CS2. The well 585 also has a suitable depth DP, at least not less than the axial length AX1, such as to enable the projectile aft end 150 to be received and accommodated within the well 585 via the inlet end 586.

In at least this example, the projectile 100 and module 500 are releasably locked in the projectile assembly 900 via a plurality of explosive bolts 587, which can be selectively actuated to fracture, thereby enabling decoupling of the projectile 100 with respect to the module 500. However, in at least some alternative variations of this example, any other suitable release mechanism as known in the art can be used instead of or in addition to explosive bolts.

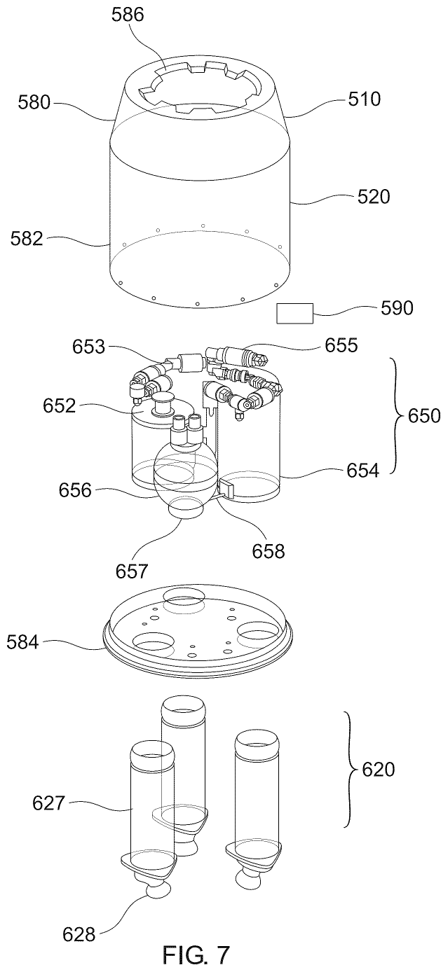

Referring in particular to FIG. 7, the module aft end 520 comprises a module propulsion system 600.

The module propulsion system 600 comprises a plurality of rocket motors 620 and a source of rocket propellant 650 operatively coupled to the rocket motors 620.

While in at least this example, the module propulsion system 600 comprises three rocket motors 620, in at least some alternative variations of this example, the respective module propulsion system can comprise two, or more than three, for example four, five, six or more than six, respective rocket motors.

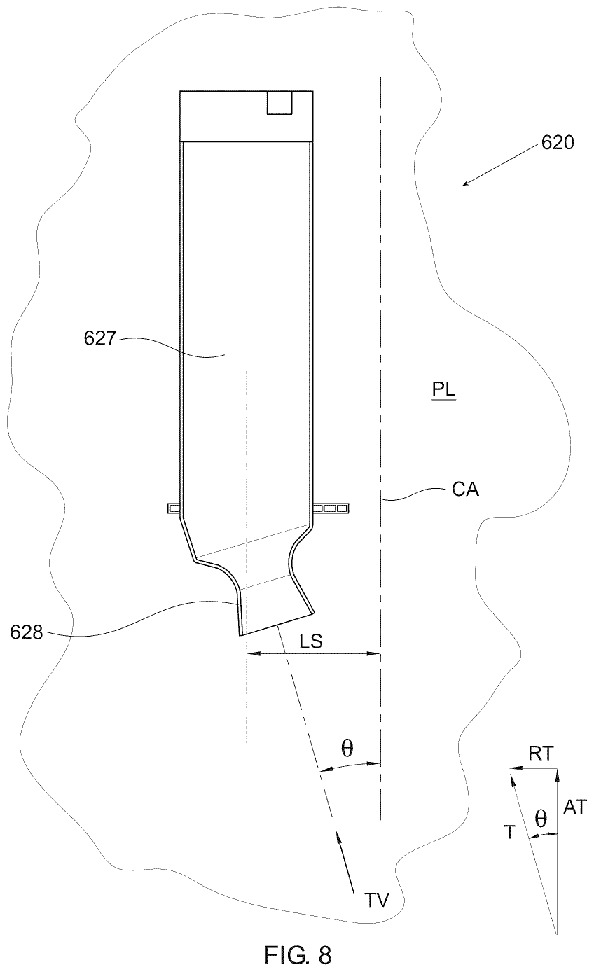

Referring also to FIG. 8, each rocket motor 620 comprises a respective combustion chamber 627 and a respective exhaust nozzle 628.

For each rocket motor 620, the respective exhaust nozzle 628 is fixedly mounted to the rocket motor 620 in alignment with the respective thrust vector TV.

Thus the direction of each thrust vector TV with respect to the module 500 is fixed.

The module 500 comprises a module casing 580, including a cylindrical wall 582 joined to bottom wall 584. The upper end of the module casing 580 is joined to the module interface 580, in particular to the inlet end 586.

The ejection module 500 further comprises, or is operatively coupled to a control unit 590.

In at least this example, the module casing 580 accommodates the module propulsion system 600 and the functions of the control unit 590 can be provided in the projectile 100, for example by the flight computer of the projectile. Thus, in at least this example, the control unit 590 is not part of the ejection module 500 per se, but rather the control unit 590 is operatively coupled to the ejection module 500. However, in at least some alternative variations of this example, the respective module casing 580 accommodates the module propulsion system 600 and the control unit 590, and in such examples, the respective ejection module 500 comprises the respective control unit 590.

In at least this example, the rocket motors 620 are configured as liquid fuel rocket motors, for example bi-propellant rocket motors, and operate to generate thrust by the combustion of propellants, the propellants including a fuel and an oxidizer.

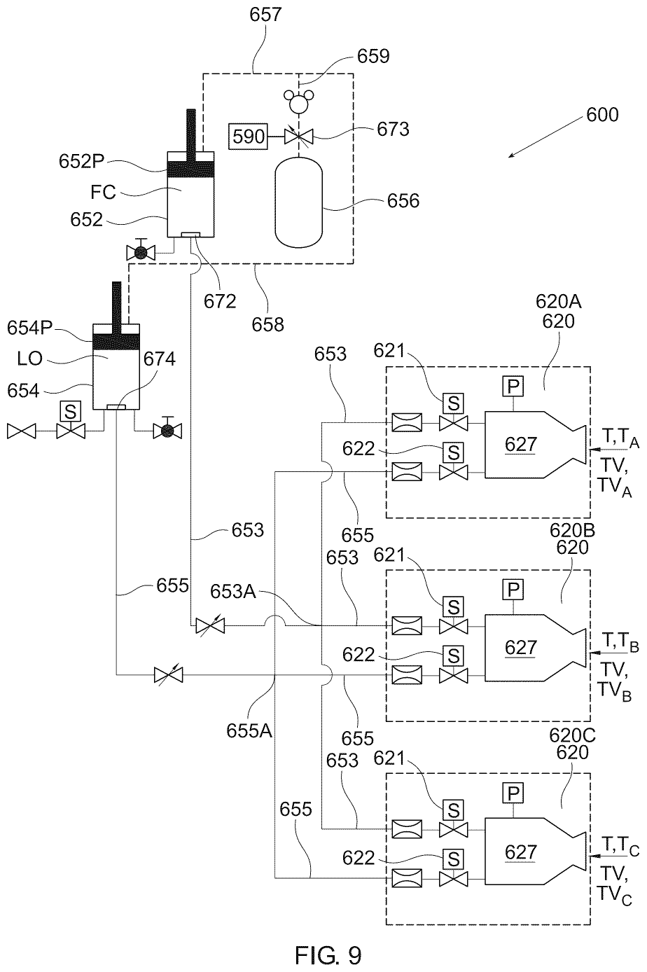

Referring in particular to FIG. 7 and FIG. 9, in at least this example, the rocket propellant source 650 of module propulsion system 600 comprises a fuel tank 652, an oxidizer tank 654, and a pressurized gas tank 656.

Suitable fuel conduits 653 interconnect the fuel tank 652 to each of the rocket motors 620 via manifold 653A.

Suitable oxidizer conduits 655 interconnect the oxidizer tank 654 to each of the rocket motors 620 via manifold 655A (FIG. 9).

Suitable pressurized gas conduits 657, 658 interconnect the pressurized gas tank 656 to the fuel tank 652 and the oxidizer tank 654, respectively, via manifold 659 (FIG. 9).

In at least this example, the fuel and oxidizer are hypergolic, and thus ignite on contact with one another within the respective combustion chamber 627 of the respective rocket motor 620. However, in at least some alternative variations of this example, the fuel and oxidizer are not hypergolic, and thus an ignitor is provided to ignite the fuel and oxidizer within the respective combustion chamber 627 of the respective rocket motor 620.

In at least this example, the fuel provided in the fuel tank 652 can be any one of kerosene, hydrazine and its derivatives, liquid hydrogen and so on, for example, the oxidizer provided in the oxidizer tank 654 is hydrogen peroxide, and the gas provided in the pressurized gas tank 656 is nitrogen. However, in alternative variations of this example, any suitable combination of fuel, oxidizer and gas can be used, for example any one of nitric acid, nitrogen tetroxide, liquid oxygen, liquid fluorine, and so on.

In at least this example, and referring to FIG. 9, the fuel tank 652 and oxidizer tank 654 are pressurized via the pressurized gas tank 656, thereby increasing the fuel pressure within the fuel tank 652 and the oxidizer pressure within the oxidizer tank 654. High pressure fuel and oxidizer flows enter the combustion chambers 627 through the control valves 621 622 which are controlled via suitable command signals from the control unit 590.

For example, the fuel tank 652 comprises a first rupture disc 672 selectively preventing fluid communication between the fuel tank 652 and the fuel conduits 653. The first rupture disc 672 is configured for rupturing and thereby establishing fluid communication between the fuel tank 652 and the fuel conduits 653, and thus establishing fluid communication between the fuel tank 652 and the rocket motors 620, when the pressure difference across the first rupture disc 672 exceeds a first predetermined threshold pressure. Furthermore, the fuel tank 652 comprises a first internal piston 652P separating the respective pressurized gas conduit 657 from the liquid fuel contents FC of the fuel tank 652. The first internal piston 652P is movable within the fuel tank 652 towards the first rupture disc 672 when subjected to gas pressure from the pressurized gas tank 656, thereby increasing the fuel pressure within the fuel tank 652. When the pressure in the fuel tank 652 exceeds the first predetermined pressure, the first rupture disc 672 ruptures, and fuel is delivered to the rocket motors 620 via the fuel conduits 653. Fluid communication between the pressurized gas tank 656 and the fuel tank 652 is controlled by valve 673, which is in turn controlled by the control unit 590. Valve 673 is normally closed, preventing fluid communication between the pressurized gas tank 656 and the fuel tank 652, and the valve 673 is selectively opened (via suitable command signals from the control unit 590) to establish fluid communication between pressurized gas tank 656 and the fuel tank 652, thus enabling the gas pressure of the pressurized gas tank 656 to be applied to the fuel tank 652 via the first piston.

Similarly, in at least this example, the oxidizer tank 654 comprises a second rupture disc 674 selectively preventing fluid communication between the oxidizer tank 654 and the oxidizer conduits 655. The second rupture disc 674 is configured for rupturing and thereby establishing fluid communication between the oxidizer tank 654 and the oxidizer conduits 655, and thus establishing fluid communication between the oxidizer tank 654 and the rocket motors 620, when the pressure difference across the second rupture disc 674 exceeds a second predetermined threshold pressure. Furthermore, the oxidizer tank 654 comprises a second internal piston 654P separating the respective pressurized gas conduit 658 from the liquid oxidizer contents LO of the oxidizer tank 654. The second internal piston 654P is movable within the oxidizer tank 654 towards the second rupture disc 674 when subjected to gas pressure from the pressurized gas tank 656, thereby increasing the fuel pressure within the oxidizer tank 654. When the pressure in the oxidizer tank 654 exceeds the second predetermined pressure, the second rupture disc 674 ruptures, and oxidizer is delivered to the rocket motors 620 via the oxidizer conduits 655. Fluid communication between the pressurized gas tank 656 and the oxidizer tank 654 is also controlled by valve 673, which is in turn controlled by the control unit 590. Valve 673 is normally closed, preventing fluid communication between the pressurized gas tank 656 and the oxidizer tank 654, and the valve 673 is selectively opened (via suitable command signals from the control unit 590) to establish fluid communication between pressurized gas tank 656 and the oxidizer tank 654, thus enabling the gas pressure of the pressurized gas tank 656 to be applied to the oxidizer tank 654 via the second piston.

Referring in particular to FIG. 9, each rocket motor 620 is coupled to the fuel tank 652 and to the oxidizer tank via respective fuel conduit 653 and respective oxidizer conduit 655.

In at least this example, the rocket propellant source 650 includes a predetermined quantity of propellant not greater than that required to enable the module 500 to propel the projectile 100 from the launch site to the control zone altitude AT and a control range RA with respect to the launch site. In particular, in at least this example, fuel tank 652 and the oxidizer tank 654 each includes a predetermined quantity of fuel and oxidizer, respectively, not greater than that required to enable the module 500 to propel the projectile 100 from the launch site to the control zone altitude AT and a control range RA with respect to the launch site.

Referring again to FIG. 8, each rocket motor 620 has a respective fixed thrust vector TV (generally co-axial with the centerline of the exhaust nozzle 628) that is non-parallel with respect to the central axis CA.

Each rocket motor 620 is configured for generating a controllable level of respective thrust T along the respective thrust vector TV, independently of the respective level of thrust generated by the other rocket motors 620 along their respective thrust vector TV.

In at least this example, and referring again to FIG. 9, each rocket motor 620 comprises respective solenoid valves 621, 622 provided in the respective fuel conduit 653 and oxidizer conduit 655, respectively. Each pair of solenoid valves 621, 622 is configured for controlling flow of fuel and oxidizer, respectively, to the respective rocket motor 620, and each pair of solenoid valves 621, 622 is operatively coupled to the control unit 590.

In each pair of solenoid valves 621, 622, the respective solenoid valves 621, 622 have a fully closed configuration C1, a fully open configuration C3, and a plurality of intermediate partially open configurations C2.

In the fully closed configuration C1, the respective pair of solenoid valves 621, 622 are fully closed, thereby preventing flow of fuel and oxidizer, respectively, to the respective rocket motor 620, and the respective rocket motor 620 generates zero thrust T₁.

In the fully open configuration C3, the respective pair of solenoid valves 621, 622 are fully open, thereby providing maximum flow communication and enabling providing maximum flow of fuel and oxidizer, respectively, to the respective rocket motor 620, and the respective rocket motor 620 generates maximum thrust T₃.

In the partially open configuration C2, the respective pair of solenoid valves 621, 622 are partially open, thereby providing partial flow communication and enabling providing partial flow of fuel and oxidizer, respectively, to the respective rocket motor 620, and the respective rocket motor 620 generates intermediate thrust T₂.

The intermediate thrust T₂ is thus less than the maximum thrust T₃ and greater than the zero thrust T₁.

Thus, the control unit 590 is capable of controlling the level of thrust generated by each of the rocket engines 620, independently of one another, via control of the respective pairs of solenoid valves 621, 622.

Referring again to FIG. 8, each rocket motor 620 is laterally (for example, radially) spaced with respect to the central axis CA by lateral spacing LS.

In at least this example, and as disclosed above, the module propulsion system 600 comprises three rocket motors 620, which are uniformly spaced circumferentially with respect to the central axis CA, at 120° angular spacings with respect to the central axis CA.

Referring for example to FIG. 9, where necessary to differentiate herein the rocket motors 620 one from the other, the first rocket motor is further designated with alphanumeric reference 620A, the second rocket motor is further designated with alphanumeric reference 620B, and the third rocket motor is further designated with alphanumeric reference 620C. Otherwise, each rocket motor is interchangeably referred to herein with alphanumeric reference 620.

Similarly, where necessary to differentiate the thrust T of the rocket motors 620A, 620B, 620C one from the other, the first thrust generated by the first rocket motor 620A is further designated with alphanumeric reference T_{A}, the second thrust generated by the second rocket motor 620B is further designated with alphanumeric reference T_{B}, and the third thrust generated by the third rocket motor 620C is further designated with alphanumeric reference T_{C}. Otherwise, the thrust generated by each rocket motor 620 is interchangeably referred to herein with alphanumeric reference T.

Similarly, where necessary to differentiate the thrust vectors TV of the rocket motors 620A, 620B, 620C one from the other, the first thrust vector of the first rocket motor 620A is further designated with alphanumeric reference TV_{A}, the second thrust vector of the second rocket motor 620B is further designated with alphanumeric reference TV_{B}, and the third thrust vector of the third rocket motor 620C is further designated with alphanumeric reference TV_{C}. Otherwise, each thrust vector is interchangeably referred to herein with alphanumeric reference TV.

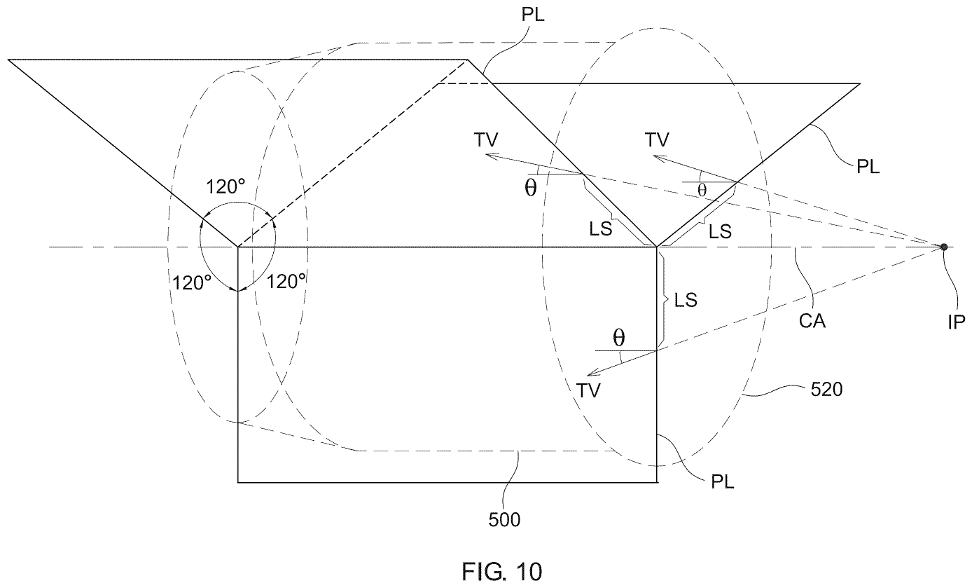

Referring to FIG. 8 and FIG. 10, each thrust vector TV lies on a respective reference plane PL, and the central axis CA also lies on each such reference plane PL. Each thrust vector TV defines a respective thrust angle θ on the respective reference plane PL with respect to the central axis CA.

In at least this example, the respective thrust angles θ of the rocket motors 620 are equal in magnitude to one another. However, in at least some alternative variations of this example, the respective thrust angles θ of the rocket motors 620 can be different in magnitude to one another.

In at least this example, each respective thrust angle θ is about 17°. However, in at least some alternative variations of this example, each thrust angle θ can have any suitable magnitude, for example in the range of between about 10° and about 30°, or in the range of between about 15° and about 20°.

In at least this example, the plurality of rocket motors 620 are arranged with respect to the central axis CA, such that the respective thrust vectors TV converge towards one another aft of the module 500.

In particular, in at least this example the plurality of rocket motors 620 are arranged with respect to the central axis CA, such that each respective thrust vector TV intersects the central axis CA at a respective intersection point IP aft of the module aft end 520, and furthermore, that the respective intersection points of the thrust vectors TV are the same point IP. In other words, in at least this example the plurality of rocket motors 620 are arranged with respect to the central axis CA, such that all the respective thrust vectors TV intersect the central axis at the same intersection point IP aft of the module aft end 520.

Referring to FIG. 8, each thrust vector TV is angled to the central axis by angle θ, such that the axial thrust AT generated by each rocket motor is provided via the expression:

$$AT = T * cos ( θ )$$

Concurrently, the thrust vector TV of each respective each rocket motor 620, by being angled to the central axis by angle θ, also provides a radial thrust RT, orthogonal to the central axis CA and along the respective reference plane PL, and the respective radial thrust RT by is provided via the expression:

$$RT = T * sin ( θ )$$

Thus, in at least this example, with angle θ being about 17°, the corresponding axial AT is about 95.63% of the respective thrust T, while the corresponding radial thrust RT is about 29.23% of the respective thrust T.

However, it can be appreciated that angle θ can have any suitable value such as to enable providing a suitable axial thrust as well as a suitable radial thrust.

The control unit 590 is configured, in operation of the module 500, for operating the module propulsion system 600 such that the first rocket motor 620A generates a first thrust T_{A}, the second rocket motor 620B concurrently generates a second thrust T_{B}, and the third rocket motor 620C concurrently generates a third thrust T_{C}, such that the first thrust T_{A}, the second thrust T_{B}, and the third thrust T_{C} together provide a module net thrust MNT and a corresponding module net thrust vector MNV.

The module 500 is configured for operating in a plurality of operational modes.

For example, in a rectilinear acceleration operational mode, the control unit 590 is configured for enabling, in particular for causing, the module 500 to execute a first acceleration maneuver AM1, wherein the first thrust T_{A}, the second thrust T_{B}, and the third thrust T_{C} are equal to one another.

Furthermore, the control unit 590 is configured for operating the module 500 to provide sufficient module net thrust MINT to launch the projectile 100 from the launch site. For this purpose, the control unit 590 operates the module propulsion system 600 such that the plurality of rocket motors 620 all provide equal thrust T to one another, enabling the module 500 to provide a module net thrust MNT co-axial with the central axis CA, and thus the corresponding module net thrust vector MNV is co-axial with the central axis CA.

In at least some examples, the control unit 590 is configured for operating the module 500 in an autonomous manner, i.e., in which the controller 590 controls the module 600 in a predefined manner and without any interference from the controller of the projectile 100.

In at least this example, for takeoff from the launch area (typically the launch tube 700), the thrusts T_{A}, T_{B}, T_{C} generated by the rocket motors 620 each corresponds to the respective maximum thrust T₃ of each rocket motor 620, to thereby provide maximum acceleration to the projectile assembly 900, and thus to the projectile 100. However, the control unit 590 can instead be operated such that the thrusts T_{A}, T_{B}, T_{C} generated by the rocket motors 620, while being equal to one another, each corresponds to a respective desired intermediate thrust T₂, to thereby provide a corresponding desired acceleration to the projectile assembly 900, and thus to the projectile 100.

In such a case, and in view of the three rocket motors 620 being equi-spaced from one another circumferentially and radially with respect to the central axis CA, the radial thrusts RT generated by the three rocket motors 620 are equal to one another and essentially balance each other out, so that there is zero net radial thrust RT generated by the module propulsion system 500.

Typically, the module net thrust MNT (when accompanied by zero net radial thrust RT) generated by the module propulsion system 600, is sufficient for the projectile assembly 900 to reach the boundary of the control zone CZ, while imparting sufficient forward velocity to the projectile 100 to enable the fins to provide aerodynamic steering and/or longitudinal stability. Furthermore, this allows for safe separation of the projectile 100 from the module 600 and activation of the propulsion system of the projectile 100. For example, in at least this example, such a forward speed is at least greater than 20 m/s, and for example up to 40 m/s. In at least some examples, the forward speed can be in the range 20 m/s to 50 m/s.

In another operational mode, the module 500 is configured for providing a turning maneuver to the projectile assembly 900. Thus, for example, in a turning operational mode, the control unit 590 is further configured for independently controlling the respective level of thrust T of each rocket motor 620 to thereby execute any desired turning maneuver in elevation μ and/or azimuth φ, prior to the module 500 being disconnected from the projectile 100, and thereby providing the desired elevation and/or azimuth to the projectile 100.

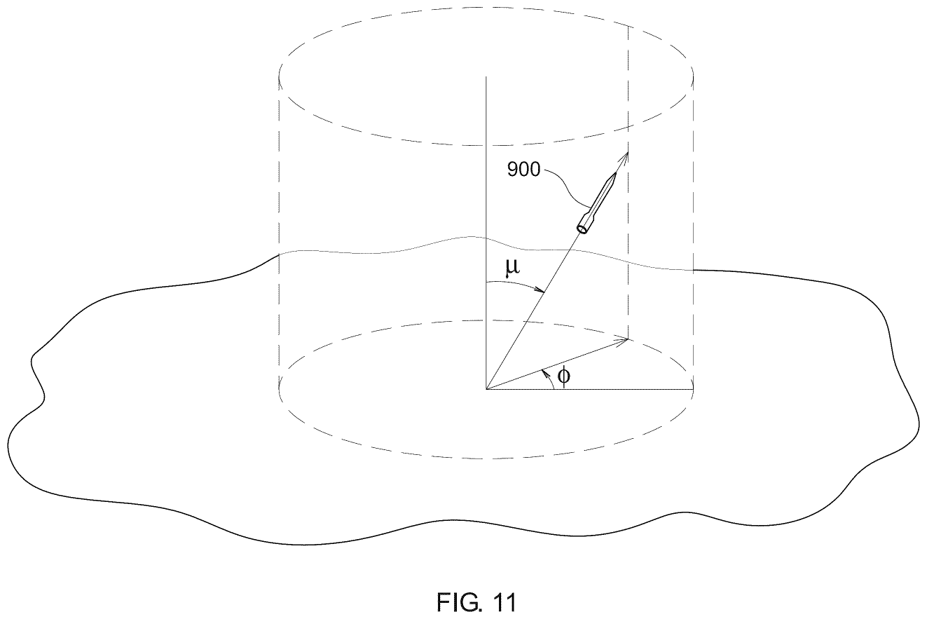

In at least this example, and referring to FIG. 11, the control unit 590 can operate to provide any desired tilt angle after launch, at least in the range between 0° and 90° in elevation μ. Furthermore, in at least this example, the control unit 590 can operate to provide, additionally or alternatively, any desired azimuth angle φ after launch, at least in the range between 0° and 360°.

In such turning maneuvers, the control unit 590 is configured for operating the module propulsion system such that at least one rocket motor 620 generates less thrust T than at least one other rocket motor 620.

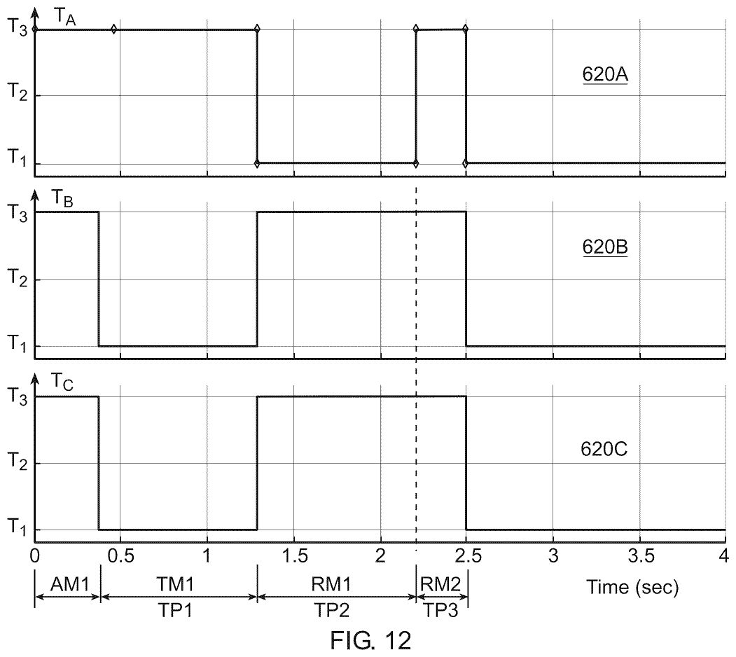

For example, and referring to FIG. 12, in one such turning operational mode, the control unit 590 is configured for enabling, in particular for causing, the module 500 to execute a first turning maneuver TM1, in which the projectile assembly 900 is to be tilted along one of the three reference planes PL associated with the module 500. This is preceded by an acceleration phase AM1.

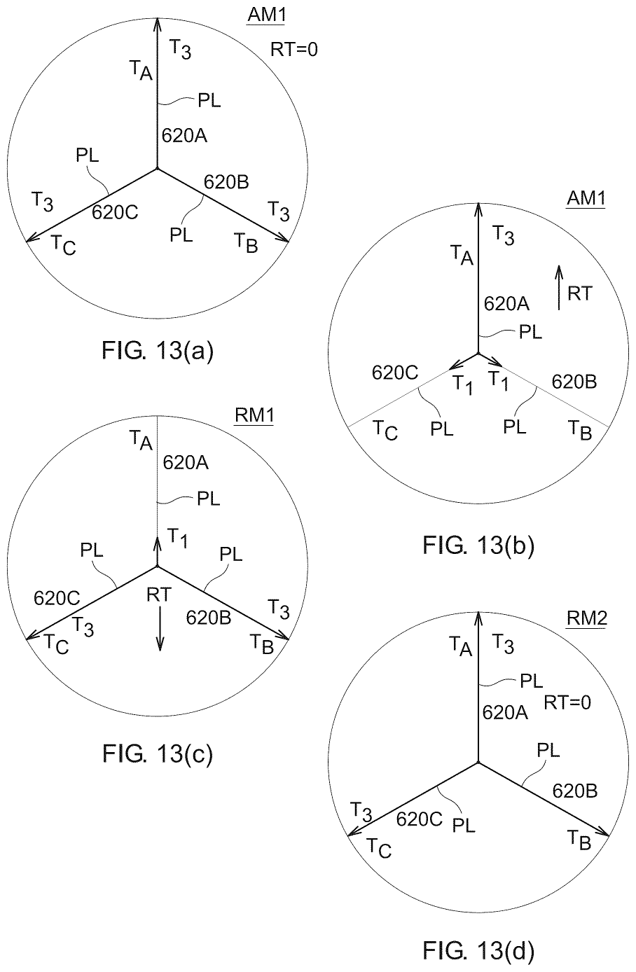

During the acceleration phase AM1, and referring also to FIG. 13(a), the three rocket motors 620A, 620B and 620C each generate the same thrust, for example the respective maximum thrust T₃, and the projectile assembly accelerates vertically upwards, i.e., there is no net radial thrust RT.

Taking the reference plane PL of the first rocket motor 620A as an example for such a first turning maneuver TM1, and referring also to FIG. 13(b), the first rocket motor 620A generates a thrust T_{A} greater than the second thrust T_{B} and the third thrust T_{C}, generated by the second rocket motor 620B or third rocket motor 620C, respectively. Thus, there is a net radial thrust RT in the direction of the first radial thrust RT_{A}. Concurrently, since the second thrust T_{B} is equal to the third thrust T_{C}, so too is the second radial thrusts RT_{B} equal to the third radial thrust RT_{C}, and thus there is no net radial thrust in the direction of the second radial thrusts RT_{B} or of the third radial thrust RT_{C}. Thus, the corresponding module net thrust vector MNV is on the respective plane PL of the first rocket motor 620A and in the direction of the radial thrust RT_{A}.

The net radial thrust RT in the direction of the first radial thrust RT_{A} provides a turning moment to the projectile assembly 900 about the center of gravity of the projectile assembly 900, and along the respective plane PL. The projectile assembly 900 thus begins to rotate about an axis orthogonal to this reference plane PL, thereby decreasing the elevation of the projectile assembly 900 from nominally 90° at launch.

In at least one example, and referring again to FIG. 12, in the first tilt maneuver TM1 the first thrust T_{A} corresponds to a nominal maximum thrust level T₃ for the first rocket motor 620A, while concurrently the second thrust T_{B} and the third thrust T_{C} are each nominally zero.

The control unit 590 is configured for executing the first tilt maneuver for a first time period TP1, such as to provide a desired elevation angle, for example 1 second or less.

Thereafter, the control unit 590 operates to halt further turning to maintain a desired elevation angle, and subsequently implements a first righting maneuver RM1 for a second time period TP2. During the second time period TP2, and referring also to FIG. 13(c), first thrust T_{A} is reduced and the second thrust T_{B} and third thrust T_{C} are each increased such that the first thrust T_{A} is less than the second thrust T_{B} or the third thrust T_{C}. Concurrently, the second thrust T_{B} is maintained equal to the third thrust T_{C}. For example, the first thrust T_{A} is reduced to the respective zero minimum thrusts T₁, and each of the second thrust T_{B}, and the third thrust T_{C} are increased to the respective maximum thrust levels T₃.

Referring also to FIG. 13(d), this is then followed by implementing a second righting maneuver RM2 for a third time period TP3, in which for the duration of the third time period the first thrust T_{A}, the second thrust T_{B}, and the third thrust T_{C} are equal to one another. For example, the three rocket motors 620A, 620B and 620C each generate the same thrust, for example the respective maximum thrust T₃.

Thereafter, the first thrust T_{A}, the second thrust T_{B}, and the third thrust T_{C} are reduced concurrently to the respective zero minimum thrusts T₁.

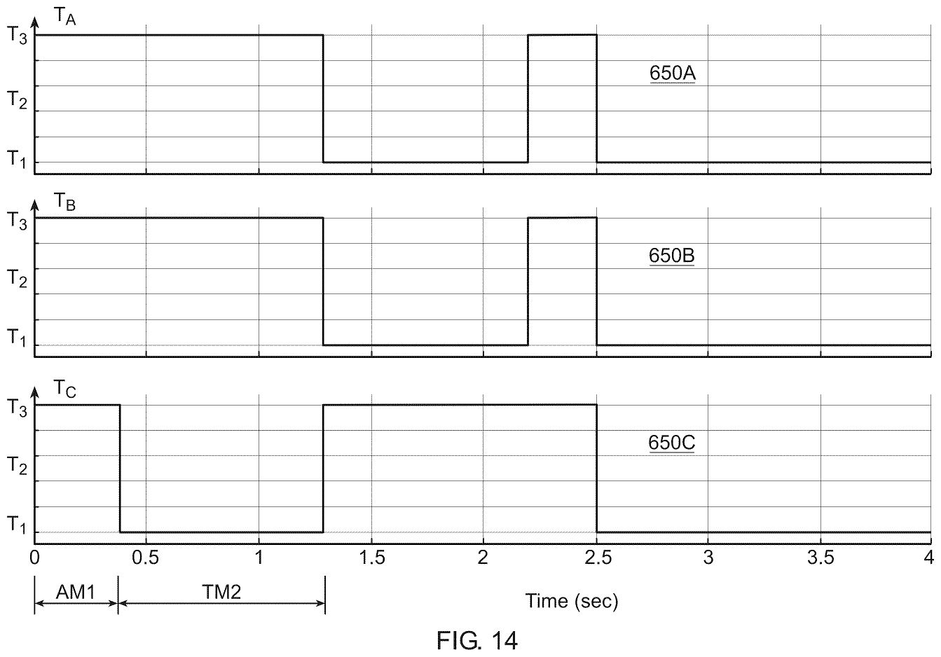

To provide a second tilt maneuver TM2 in the opposite direction to first radial thrust RT_{A}, and referring to FIG. 14, instead of providing a first thrust T_{A} that is greater than the second thrust T_{B} or the third thrust T_{C}, the control unit 590 operates to provide the second thrust T_{B} and the third thrust T_{C} greater than the first thrust T_{A}, while maintaining the second thrust T_{B} equal to the third thrust T_{C}

A similar tilt maneuver can instead be provided about the reference plane PL corresponding to the second motor 620B or corresponding to the third motor 620C, in a similar manner to the above relating to the first motor 620A, mutatis mutandis.

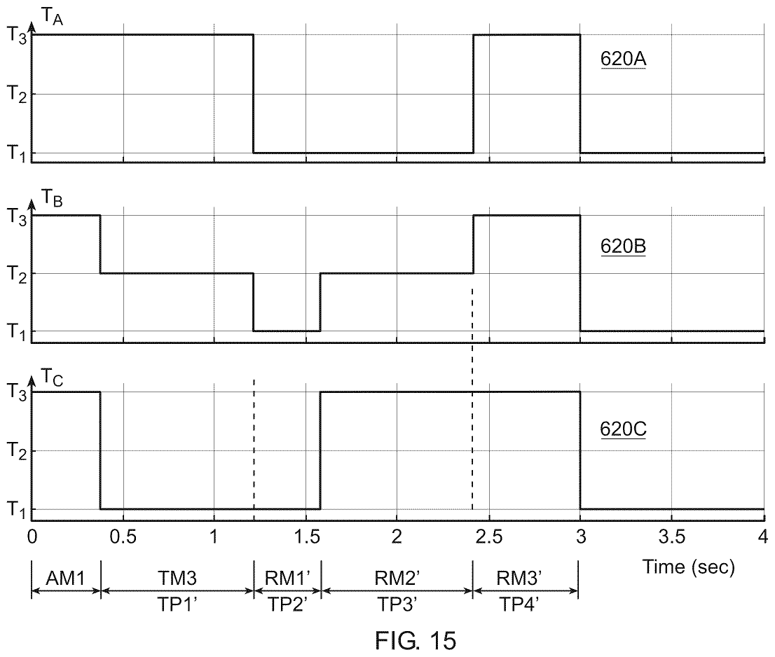

For example, and referring to FIG. 15, in another such turning operational mode, the control unit 590 is configured for enabling, in particular for causing, the module 500 to execute a second turning maneuver, in which the projectile assembly 900 is to be tilted along a plane PI intermediate to two of the three reference planes PL associated with the module 500, thereby providing a desired change in azimuth as well as elevation.

This is preceded by an acceleration phase AM1, and referring again to FIG. 13(a), the three rocket motors 620A, 620B and 620C each generate the same thrust, for example the respective maximum thrust T₃, and the projectile assembly accelerates vertically upwards, i.e., there is no net radial thrust RT, in a similar manner to prior to the first turning maneuver TM1, mutatis mutandis.

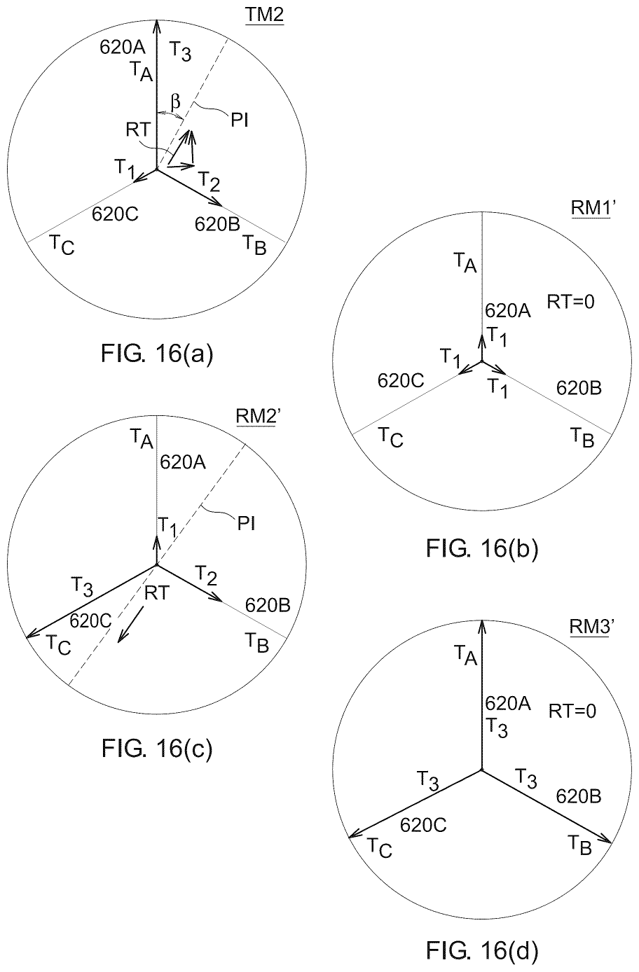

Taking an intermediate plane PI intermediate the reference planes PL of the first rocket motor 620A and of the second rocket motor 620B as an example for such a second maneuver, and referring also to FIG. 16(a), the control unit 590 is configured for enabling the module 500 to execute a third tilt maneuver TM3, wherein the first thrust T_{A} by the first rocket motor 620A is greater than the second thrust T_{B} generated by the second rocket motor 620B or the third thrust T_{C} generated by the third rocket motor 620C, and wherein concurrently the second thrust T_{B} is greater than the third thrust T_{C}. The vector difference between the second thrust T_{B} and the third thrust T_{C} provides the desired azimuth, while the vector difference between the first thrust T_{A} and the combination of the second thrust T_{B} and the third thrust T_{C} provides the desired elevation.

In such a case, a first radial thrust RT_{A} corresponding to the first thrust T_{A} is greater than the sum of the radial thrusts RT_{B} and RT_{C} corresponding to the second thrust T_{B} and the third thrust T_{C}, respectively. Thus, there is a net radial thrust RT in the direction of the first radial thrust RT_{A}, which provides a turning moment about the center of gravity of the projectile assembly 900, thereby decreasing the elevation of the projectile assembly 900 from nominally 90° at launch.

Concurrently, since the second thrust T_{B} is greater than the third thrust T_{C}, there is also a net radial thrust RT in the direction of the second radial thrusts RT_{B}, which provides a turning moment about the center of gravity of the projectile assembly 900 thereby providing a change in azimuth.

In cases where the third thrust T_{C} is greater than the second thrust T_{B}, then there is instead a radial thrust RT in the direction of the third thrust T_{C}, which provides a turning moment about the center of gravity of the projectile assembly 900 in azimuth in the opposite direction.

In any case, the net effect is that the projectile assembly 900 follows a turning trajectory along the intermediate plane PI, which is inclined to the reference plane PL associated with the first rocket motor 620A by a displacement angle β provided by the vector sum of the net radial thrust RT in the direction of the first radial thrust RT_{A}, and the net radial thrust RT in the direction of the second radial thrusts RT_{B} or of the third thrust T_{C} (depending on whether the second thrust T_{B} is greater than or less than, respectively, the third thrust T_{C}).

The displacement angle β (and thus the azimuth) can be controlled by suitably controlling the ratio of the second thrust T_{B} with respect to the third thrust T_{C}.

The vector combination of the first radial thrust RT_{A}, the second radial thrust RT_{B}, and the third radial thrust RT_{C} provides a net radial thrust NRT, and thus a turning moment to the projectile assembly 900, along the respective intermediate plane PI, and the projectile assembly 900 begins to rotate about an axis orthogonal to this intermediate plane PI, thereby decreasing the elevation of the projectile assembly 900 from nominally 90° at launch and concurrently changing the azimuth as well.

In at least one example, and referring again to FIG. 15, in the third tilt maneuver TM3 the first thrust T_{A} corresponds to a nominal maximum thrust level T₃ for the first rocket motor 620A, while concurrently the third thrust T_{C} is the respective zero minimum thrusts T₁, and the second thrust T_{B} has a respective intermediate thrust T₂, the magnitude of which is intermediate the first thrust T_{A} and the third thrust T_{C}.

The control unit 590 is configured for executing the third tilt maneuver TM3 for a first time period TP1′, such as to provide a desired elevation angle and a desired azimuth angle, for example 1 second or less.

Thereafter, and referring also to FIG. 16(b), the control unit 590 operates to halt further turning to maintain a desired elevation angle and a desired azimuth angle, and subsequently implements a first righting maneuver RM1′ for a second time period TP2′. During the second time period TP2′, the first thrust T_{A}, the second thrust T_{B}, and the third thrust T_{C} are each decreased to the respective zero minimum thrusts T₁.

Referring also to FIG. 16(c), this is then followed by implementing a second righting maneuver RM2′ for a third time period TP3′, in which for the duration of the third time period the third thrust T_{C} is increased and the second thrust T_{B} is increased such that the third thrust T_{C} is greater than the second thrust T_{B}, which is greater than the first thrust T_{A}.

Referring also to FIG. 16(d), this is then followed by implementing a third righting maneuver RM3′ for a fourth time period TP4′, in which for the duration of the fourth time period the first thrust T_{A}, the second thrust T_{B}, and the third thrust T_{C} are equal to one another, and each is at the respective maximum thrust T₃.

Thereafter, the first thrust T_{A}, the second thrust T_{B}, and the third thrust T_{C} are reduced concurrently to the respective zero minimum thrusts T₁.

To provide a tilt maneuver along any other desired plane PI, the control unit 590 operates to provide the appropriate ratio between the first thrust T_{A}, the second thrust T_{B} and the third thrust T_{C}.

It is to be noted that the desired intermediate plane PI, or the desired reference plane PL, along which the projectile assembly 900 is to follow an initial trajectory, can be chosen such as to essentially point the projectile in the corresponding azimuth to the intended target, concurrently changing the elevation of the projectile assembly 900 to any desired elevation, prior to the module 500 being ejected and at a relatively low altitude, so that the projectile 100 can then continue under its own power to the target. For example, the desired elevation can be in the range −20° to 80°, or for example from 0° to 40°, or for example from 20° to 30°, depending in the specific mission parameters, for example.

It is also to be noted that the desired intermediate plane PI, or the desired reference plane PL, along which the projectile assembly 900 is to follow an initial trajectory, can take into account side winds that could otherwise deviate the projectile assembly 900, and the projectile 100 once the module 500 is ejected, from the desired trajectory to the target.

In at least this example, the control unit 590 can further operate to control the trajectory of the projectile assembly 900 to correct for disturbances that can be caused by external forces, including for example wind, turbulence, movements induced to the launch tube (for example in examples where the launch tube is fixed to a ship), and so on.

In at least this example, the projectile assembly 900 (for example the projectile 100 or the module 500) can comprise an inertial measurement unit (IMU), which can operate to monitor, for example on a continuous basis, the behavior of the projectile assembly 900 in three-dimensional space, and which can provide input to the control unit 590 to correct for any deviation from the required trajectory.

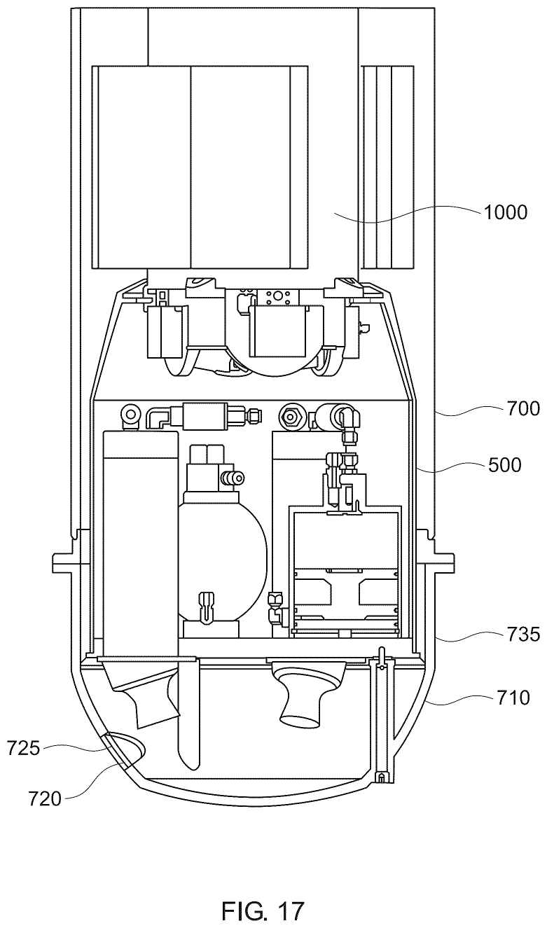

Referring to FIG. 17, in at least this example, the launch tube 700 has a closed bottom end 710. The inside diameter of the launch tube 700 is greater than the effective external diameter of the projectile assembly 900 by a radial gap RGP.

In at least this example, the launch tube 700 includes an excess pressure venting arrangement 720 configured for enabling venting of the launch tube 700 responsive to a pressure within the launch tube 700 exceeding a predetermined threshold pressure PB. Such a buildup of pressure can occur for example in a case of malfunction when the projectile is stuck in the launch tube for any reason. In such a case, the pressure relief valve will enable releasing the pressure, preventing the launch tube from bursting.

In at least this example, the launch tube 700 comprises a launch tube casing 730, and at least one venting opening 735, and the excess pressure venting arrangement 720 comprises a burst disc 725 provided in the respective venting opening 725. The burst disc 725 is configured for bursting when subjected to a pressure exceeding the predetermined threshold pressure PB.

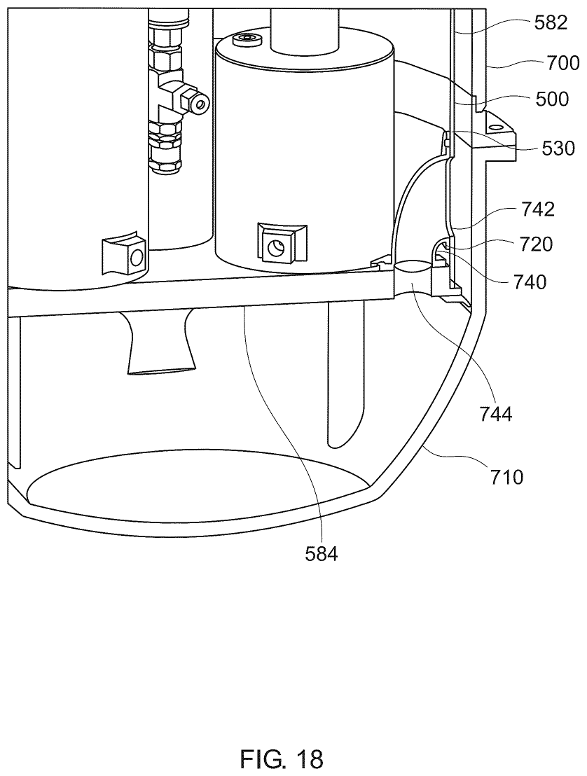

Additionally or alternatively, and referring to FIG. 18, the excess pressure venting arrangement 720 comprises a plurality of vent tubes 740 provided in the module 500.

Each vent tube 740 comprises an open inlet end 744 at the bottom wall 584, and an open outlet end 742 provided in the cylindrical wall 582.

Thus, exhaust gasses accumulating aft of the module 500 can be vented to the radial gap RGP via the vent tubes 740.

In at least some alternative variations of the above examples, the respective launch tube can have an open bottom end.

The launch system 990 can be operated, for example as follows.

In a first, launching, step, the projectile assembly 900 is selectively launched from the launch tube 700 by operating the module propulsion system 600 to generate net thrust sufficient to at least eject the projectile assembly 900 outside of the control zone CZ around the launch tube 700.

In one example of such a step, and referring to FIG. 12 and FIGS. 13(a) to 13(d), the module propulsion system 500 is operated such that the first rocket motor 620A generates a first thrust T_{A}, the second rocket motor 620B concurrently generates a second thrust T_{B}, and the third rocket motor 620C concurrently generates a third thrust T_{C}, such that the first thrust T_{A}, the second thrust T_{B} and the third thrust T_{C} together provide a module net thrust and a corresponding module thrust vector.

Initially, and referring also to FIG. 12 and FIGS. 13(a) to 13(d), the module propulsion system 500 is operated to provide a first acceleration maneuver AM1, for example as disclosed herein, wherein the first thrust T_{A}, the second thrust T_{B} and the third thrust T_{C} are equal to one another.

Thereafter, the module propulsion system 500 can be operated to execute a first tilt maneuver TM1, for example as disclosed herein, wherein the first thrust T_{A} is greater than the second thrust T_{B} or the third thrust T_{C}, and wherein the second thrust T_{B} is equal to the third thrust T_{C}. for example, the first thrust corresponds to a nominal maximum thrust level T₃ for the first rocket motor 620A, and the second thrust T_{B} and the third thrust T_{C} are each respective zero minimum thrusts T₁.

For example, the first tilt maneuver TM1 is executed for a first time period TP1, and this is followed by:
(I) subsequently implementing a first righting maneuver RM1 for a second time period TP2, wherein for the second time period TP2 the first thrust T_{A} is less than the second thrust T_{B} or the third thrust T_{C}, and wherein the second thrust T_{B} is equal to the third thrust T_{C},
(II) subsequent to step (I) implementing a second righting maneuver RM2 for a third time period TP3, wherein for the third time period TP3 the first thrust T_{A}, the second thrust T_{B} and the third thrust T_{C} are equal to one another.

In another example of such a step, and referring to FIG. 14 the module executes a second tilt maneuver, for example as disclosed herein, in which the first thrust T_{A} is less than the second thrust T_{B} or the third thrust T_{C}, and wherein the second thrust T_{B} is equal to the third thrust T_{C}.

In another example of such a step, and referring to FIG. 15 and FIGS. 16(a) to 16(d), the module 500 executes a third tilt maneuver TM3, for example as disclosed herein, wherein the first thrust T_{A} is greater than the second thrust T_{B} or the third thrust T_{C}, and wherein the second thrust T_{B} is greater than the third thrust T_{C}.

For example, the first thrust T_{A} corresponds to a nominal maximum thrust level T₃ for the first rocket motor 620A, and the third thrust T_{C} is the respective zero minimum thrust T₁, and the second thrust T_{B} is at a respective intermediate thrust T₂, the magnitude of which is intermediate the first thrust T_{A} and the third thrust T_{C}.

For example, the third tilt maneuver TM3 is executed for a first time period, and this is followed by:
(i) subsequently implementing a first righting maneuver RM1′ for a second time period TP2′ wherein for the second time period TP2′ the first thrust T_{A}, the second thrust T_{B} and the third thrust T_{C} are each nominally zero,
(ii) subsequent to step (i), implementing a second righting maneuver RM2′ for a third time period TP3′, wherein for the third time period TP3′ the third thrust T_{C} is greater than the second thrust T_{B}, and the second thrust T_{B} is greater than the first thrust T_{A},
(iii) subsequent to step (ii), implementing a third righting maneuver RM3′ for a fourth time period TP4′, wherein for the fourth time period TP4′ the first thrust T_{A}, the second thrust T_{B} and the third thrust T_{C} are equal to one another.

In a second, decoupling, step, the module 500 is selectively decoupled from the projectile 100 according to predetermined criteria.

Such predetermined criteria includes a first criterion, wherein the first criterion requires the projectile assembly 900 to be just outside of the control zone CZ.

In at least some alternative variations of this example, in which the respective module propulsion system comprises only two such rocket motors, the rocket motors are circumferentially spaced at 180° from one another, and provide control of the elevation of the respective projectile assembly. In such examples, the projectile assembly can be manually oriented to the desired azimuth by either fixedly setting the projectile assembly in such an azimuth at least prior to launch, or by mounting the projectile assembly on a turntable or turret, which can be rotated about a vertical axis to provide the desired azimuth.

In the method claims that follow, alphanumeric characters and Roman numerals used to designate claim steps are provided for convenience only and do not imply any particular order of performing the steps.

Finally, it should be noted that the word “comprising” as used throughout the appended claims is to be interpreted to mean “including but not limited to”.

While there has been shown and disclosed examples in accordance with the presently disclosed subject matter, it will be appreciated that many changes may be made therein without departing from the scope of the presently disclosed subject matter as set out in the claims.

1. An ejection module for ejecting a projectile, the module comprising:
a module forward end comprising a central axis and a module interface, the module interface configured for selectively enabling the module to be selectively affixed to the projectile in a load-bearing manner, and for enabling selective disconnection between the module and the projectile; and
a module aft end comprising a module propulsion system, the module propulsion system comprising a plurality of rocket motors and a source of rocket propellant, wherein:
each said rocket motor is laterally spaced with respect to the central axis,
each said rocket motor has a respective fixed thrust vector non-parallel with respect to the central axis,
each said rocket motor is configured for generating a controllable level of respective thrust along the respective said thrust vector, independently of the respective level of thrust generated by the other said rocket motors along their respective thrust vectors;
wherein the module propulsion system is configured for enabling independently controlling the respective said level of thrust of each said rocket motor.

2. The module according to claim 1, wherein said source of rocket propellant includes a predetermined quantity of propellant not greater than that required to enable the module to propel the projectile from a launch site to a predetermined range and predetermined altitude with respect to the launch site, wherein said predetermined range and said predetermined altitude correspond to a minimum safe range and a minimum safe altitude with respect to the launch site.

3. The module according to claim 2, including at least one of the following:
wherein said minimum safe range and said minimum safe altitude ensures or minimizes potential damage to the launch site in event of the projectile failing to operate after disconnection from the ejection module and falls back to Earth under gravity;
wherein said predetermined safe range is between 50 m and about 70 m;
wherein said predetermined safe altitude is between about 30 m and about 20 m.

4. (canceled)

5. (canceled)

6. The ejection module according to claim 1, configured for providing any desired tilt after launch at least between 90° and 0° in elevation.

7. The ejection module according to claim 1, configured for providing any desired azimuth after launch at least between 0° and 360°.

8. The ejection module according to claim 1, wherein each said thrust vector converges towards the central axis at a respective intersection point aft of the module aft end.

9. The ejection module according to claim 8, wherein the respective intersection points of the thrust vectors are the same point.

10. The ejection module according to claim 1, including one of the following
wherein each said thrust vector lies on a respective plane, and wherein said central axis lies on each said plane;
wherein each said thrust vector lies on a respective plane, and wherein said central axis lies on each said plane, and, wherein each said thrust vector defines a respective thrust angle on the respective plane with respect to the central axis;
wherein each said thrust vector lies on a respective plane, and wherein said central axis lies on each said plane, and, wherein each said thrust vector defines a respective thrust angle on the respective plane with respect to the central axis, and, wherein the respective thrust angles of said rocket motors are equal in magnitude to one another;
wherein each said thrust vector lies on a respective plane, and wherein said central axis lies on each said plane, and, wherein each said thrust vector defines a respective thrust angle on the respective plane with respect to the central axis, and, wherein each said thrust angle is in the range of between about 10° and about 30°.

11. (canceled)

12. (canceled)

13. (canceled)

14. The ejection module according to claim 1, including at least one of the following:
wherein said rocket motors are configured as liquid fuel rocket motors, and wherein said source of rocket propellant includes at least one liquid fuel tank and at least one oxidizer tank;
further comprising a control unit operatively coupled to the module propulsion system, the control unit being configured for enabling independently controlling the respective said level of thrust of each said rocket motor.

15. The ejection module according to claim 1,
configured for providing a forward velocity to the projectile at least sufficient to enable the projectile to steer via fins;
configured for providing a forward velocity to the projectile at least greater than 20 m/s.

16. (canceled)

17. (canceled)

18. The ejection module according to claim 17, including one of the following:
wherein the control unit is accommodated in the ejection module;
wherein the control unit is accommodated in the projectile;
wherein said control unit is configured for operating the module to provide sufficient thrust to launch the projectile;
wherein said control unit is configured for operating the module propulsion system such that the plurality of said rocket motors provide equal thrust to enable the module to provide a net thrust co-axial with the central axis;
wherein said control unit is configured for operating the module propulsion system to provide any desired tilt maneuver;
wherein said control unit is configured for operating the module propulsion system to provide any desired tilt maneuver, and, wherein said control unit is configured for operating the module propulsion system such that at least one said rocket motor generates less thrust than at least one other said rocket motor.

19. (canceled)

20. (canceled)

21. (canceled)

22. (canceled)

23. (canceled)

24. The ejection module according to claim 1, including one of the following:
wherein said module propulsion system comprises a first said rocket motor, a second said rocket motor and a third said rocket motor, wherein said first rocket motor, said second rocket motor and said third rocket motor are uniformly spaced circumferentially with respect to the central axis;
wherein said module propulsion system comprises a first said rocket motor, a second said rocket motor and a third said rocket motor, wherein said first rocket motor, said second rocket motor and said third rocket motor are uniformly spaced circumferentially with respect to the central axis, and, wherein each said rocket motor comprises a respective exhaust nozzle fixedly mounted to the rocket motor in alignment with the respective said thrust vector;
wherein said module propulsion system comprises a first said rocket motor, a second said rocket motor and a third said rocket motor, wherein said first rocket motor, said second rocket motor and said third rocket motor are uniformly spaced circumferentially with respect to the central axis, and, wherein the control unit is configured for operating the module propulsion system such that the first rocket motor generates a first said thrust, the second rocket motor concurrently generates a second said thrust, and the third rocket motor concurrently generates a third said thrust, such that the first thrust, the second thrust and the third thrust together provide a module net thrust and a corresponding module thrust vector;
wherein said module propulsion system comprises a first said rocket motor, a second said rocket motor and a third said rocket motor, wherein said first rocket motor, said second rocket motor and said third rocket motor are uniformly spaced circumferentially with respect to the central axis, and, wherein the control unit is configured for operating the module propulsion system such that the first rocket motor generates a first said thrust, the second rocket motor concurrently generates a second said thrust, and the third rocket motor concurrently generates a third said thrust, such that the first thrust, the second thrust and the third thrust together provide a module net thrust and a corresponding module thrust vector, and, operable for selectively causing the module to execute a first acceleration maneuver, wherein said first thrust, said second thrust and said third thrust are equal to one another;
wherein said module propulsion system comprises a first said rocket motor, a second said rocket motor and a third said rocket motor, wherein said first rocket motor, said second rocket motor and said third rocket motor are uniformly spaced circumferentially with respect to the central axis, and, wherein the control unit is configured for operating the module propulsion system such that the first rocket motor generates a first said thrust, the second rocket motor concurrently generates a second said thrust, and the third rocket motor concurrently generates a third said thrust, such that the first thrust, the second thrust and the third thrust together provide a module net thrust and a corresponding module thrust vector, and, operable for selectively causing the module to execute a first tilt maneuver, wherein said first thrust is greater than said second thrust or said third thrust, and wherein said second thrust is equal to said third thrust;
wherein said module propulsion system comprises a first said rocket motor, a second said rocket motor and a third said rocket motor, wherein said first rocket motor, said second rocket motor and said third rocket motor are uniformly spaced circumferentially with respect to the central axis, and, wherein the control unit is configured for operating the module propulsion system such that the first rocket motor generates a first said thrust, the second rocket motor concurrently generates a second said thrust, and the third rocket motor concurrently generates a third said thrust, such that the first thrust, the second thrust and the third thrust together provide a module net thrust and a corresponding module thrust vector, and, wherein said first thrust corresponds to a nominal maximum thrust level for the said first rocket motor, and wherein said second thrust and said third thrust are each nominally zero;
wherein said module propulsion system comprises a first said rocket motor, a second said rocket motor and a third said rocket motor, wherein said first rocket motor, said second rocket motor and said third rocket motor are uniformly spaced circumferentially with respect to the central axis, and, wherein the control unit is configured for operating the module propulsion system such that the first rocket motor generates a first said thrust, the second rocket motor concurrently generates a second said thrust, and the third rocket motor concurrently generates a third said thrust, such that the first thrust, the second thrust and the third thrust together provide a module net thrust and a corresponding module thrust vector, and, operable for executing said first tilt maneuver for a first time period, and for subsequently implementing a first righting maneuver for a second time period wherein for said second time period the said first thrust is less than said second thrust or said third thrust, and wherein said second thrust is equal to said third thrust, followed by implementing a second righting maneuver for a third time period, wherein for said third time period said first thrust, said second thrust and said third thrust are equal to one another;
wherein said module propulsion system comprises a first said rocket motor, a second said rocket motor and a third said rocket motor, wherein said first rocket motor, said second rocket motor and said third rocket motor are uniformly spaced circumferentially with respect to the central axis, and, wherein the control unit is configured for operating the module propulsion system such that the first rocket motor generates a first said thrust, the second rocket motor concurrently generates a second said thrust, and the third rocket motor concurrently generates a third said thrust, such that the first thrust, the second thrust and the third thrust together provide a module net thrust and a corresponding module thrust vector, and, operable for enabling the module to execute a second tilt maneuver, wherein said first thrust is less than said second thrust or said third thrust, and wherein said second thrust is equal to said third thrust;
wherein said module propulsion system comprises a first said rocket motor, a second said rocket motor and a third said rocket motor, wherein said first rocket motor, said second rocket motor and said third rocket motor are uniformly spaced circumferentially with respect to the central axis, and, wherein the control unit is configured for operating the module propulsion system such that the first rocket motor generates a first said thrust, the second rocket motor concurrently generates a second said thrust, and the third rocket motor concurrently generates a third said thrust, such that the first thrust, the second thrust and the third thrust together provide a module net thrust and a corresponding module thrust vector, and, operable for enabling the module to execute a third tilt maneuver, wherein said first thrust is greater than said second thrust or said third thrust, and wherein said second thrust is greater than said third thrust;
wherein said module propulsion system comprises a first said rocket motor, a second said rocket motor and a third said rocket motor, wherein said first rocket motor, said second rocket motor and said third rocket motor are uniformly spaced circumferentially with respect to the central axis, and, wherein the control unit is configured for operating the module propulsion system such that the first rocket motor generates a first said thrust, the second rocket motor concurrently generates a second said thrust, and the third rocket motor concurrently generates a third said thrust, such that the first thrust, the second thrust and the third thrust together provide a module net thrust and a corresponding module thrust vector, and, operable for enabling the module to execute a third tilt maneuver, wherein said first thrust is greater than said second thrust or said third thrust, and wherein said second thrust is greater than said third thrust, and, wherein said first thrust corresponds to a nominal maximum thrust level for the said first rocket motor, and wherein said third thrust is nominally zero, and wherein said second thrust is intermediate in magnitude between said first thrust and said third thrust;
wherein said module propulsion system comprises a first said rocket motor, a second said rocket motor and a third said rocket motor, wherein said first rocket motor, said second rocket motor and said third rocket motor are uniformly spaced circumferentially with respect to the central axis, and, wherein the control unit is configured for operating the module propulsion system such that the first rocket motor generates a first said thrust, the second rocket motor concurrently generates a second said thrust, and the third rocket motor concurrently generates a third said thrust, such that the first thrust, the second thrust and the third thrust together provide a module net thrust and a corresponding module thrust vector, and, operable for enabling the module to execute a third tilt maneuver, wherein said first thrust is greater than said second thrust or said third thrust, and wherein said second thrust is greater than said third thrust, and, wherein said first thrust corresponds to a nominal maximum thrust level for the said first rocket motor, and wherein said third thrust is nominally zero, and wherein said second thrust is intermediate in magnitude between said first thrust and said third thrust, and, wherein the control unit is configured for executing said third tilt maneuver for a first time period, and for subsequently implementing a first righting maneuver for a second time period wherein for said second time period said first thrust, said second thrust and said third thrust are each nominally zero, followed by implementing a second righting maneuver for a third time period, wherein for said third time period said third thrust is greater than said second thrust, and said second thrust is greater than said first thrust, followed by implementing a third righting maneuver for a fourth time period, wherein for said fourth time period said first thrust, said second thrust and said third thrust are equal to one another;
wherein said module propulsion system comprises a first said rocket motor, a second said rocket motor and a third said rocket motor, wherein said first rocket motor, said second rocket motor and said third rocket motor are uniformly spaced circumferentially with respect to the central axis, and, wherein the control unit is configured for operating the module propulsion system such that the first rocket motor generates a first said thrust, the second rocket motor concurrently generates a second said thrust, and the third rocket motor concurrently generates a third said thrust, such that the first thrust, the second thrust and the third thrust together provide a module net thrust and a corresponding module thrust vector, and, operable for enabling the module to execute a third tilt maneuver, wherein said first thrust is greater than said second thrust or said third thrust, and wherein said second thrust is less than said third thrust;
wherein said module propulsion system comprises a first said rocket motor, a second said rocket motor and a third said rocket motor, wherein said first rocket motor, said second rocket motor and said third rocket motor are uniformly spaced circumferentially with respect to the central axis, and, wherein the control unit is configured for operating the module propulsion system such that the first rocket motor generates a first said thrust, the second rocket motor concurrently generates a second said thrust, and the third rocket motor concurrently generates a third said thrust, such that the first thrust, the second thrust and the third thrust together provide a module net thrust and a corresponding module thrust vector, and, operable for enabling the module to execute a third tilt maneuver, wherein said first thrust is greater than said second thrust or said third thrust, and wherein said second thrust is less than said third thrust, and, wherein said third tilt maneuver is configured to provide a desired change in azimuth during execution of said third tilt maneuver.

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. A projectile assembly, comprising:
a projectile having a projectile propulsion system and an aft projectile end, the aft projectile end comprising a projectile interface;
an ejection module as defined in claim 1;
wherein the projectile interface is configured for being selectively and reversibly coupled with respect to the module interface, such that when thus coupled the module is reversibly affixed to the projectile in a load-bearing manner, and such that when the projectile interface is decoupled with respect to the module interface, the module is disconnected from the projectile.

38. The projectile assembly according to claim 37, wherein the projectile comprises a plurality of fins.

39. A launch system comprising:
a projectile assembly as defined in claim 37;
a launch tube configured for accommodating the projectile launch assembly therein at least in a launch-ready configuration, and for enabling selective launch of the projectile launch assembly from the launch tube.

40. The launch system according to claim 39, wherein said launch tube has a closed bottom end, and wherein said launch tube includes an excess pressure venting arrangement configured for enabling venting of the launch tube responsive to a pressure within the launch tube exceeding a predetermined threshold pressure.

41. A method for launching a projectile, comprising:
(a) providing a launch system as defined in claim39;
(b) selectively launching the projectile launch assembly from the launch tube by operating the module propulsion system to generate thrust sufficient to at least eject the projectile launch assembly outside of a control zone around the launch tube;
(c) decoupling the module from the projectile according to predetermined criteria including a first criterion, wherein said first criterion requires the projectile launch assembly to be outside of said control zone.

42. The method according to claim 41, wherein at least during step (b) the projectile propulsion system is not operated.

43. The method according to claim 41 wherein the module propulsion system is operated such that the first rocket motor generates a first said thrust, the second rocket motor concurrently generates a second said thrust, and the third rocket motor concurrently generates a third said thrust, such that the first thrust, the second thrust and the third thrust together provide a module net thrust and a corresponding module thrust vector.

44. The method according to claim 43, including one of the following:
wherein said first thrust, said second thrust and said third thrust are equal to one another;
wherein the module executes a first tilt maneuver, wherein said first thrust is greater than said second thrust or said third thrust, and wherein said second thrust is equal to said third thrust;
wherein the module executes a first tilt maneuver, wherein said first thrust is greater than said second thrust or said third thrust, and wherein said second thrust is equal to said third thrust, and, wherein said first tilt maneuver is executed for a first time period, and further comprising;
(I) subsequently implementing a first righting maneuver for a second time period wherein for said second time period the said first thrust is less than said second thrust or said third thrust, and wherein said second thrust is equal to said third thrust,
(II) (II) subsequent to step (I) implementing a second righting maneuver for a third time period, wherein for said third time period said first thrust, said second thrust and said third thrust are equal to one another;
wherein the module executes a third tilt maneuver, wherein said first thrust is greater than said second thrust or said third thrust, and wherein said second thrust is greater than said third thrust;
wherein the module executes a third tilt maneuver, wherein said first thrust is greater than said second thrust or said third thrust, and wherein said second thrust is greater than said third thrust, and, wherein said first thrust corresponds to a nominal maximum thrust level for the said first rocket motor, and wherein said third thrust is nominally zero, and wherein said second thrust is intermediate in magnitude between said first thrust and said third thrust;
wherein the module executes a third tilt maneuver, wherein said first thrust is greater than said second thrust or said third thrust, and wherein said second thrust is greater than said third thrust, and, wherein the third tilt maneuver is executed for a first time period, and further comprising:
(i) subsequently implementing a first righting maneuver for a second time period wherein for said second time period said first thrust, said second thrust and said third thrust are each nominally zero,
(ii) subsequent to step (i), implementing a second righting maneuver for a third time period, wherein for said third time period said third thrust is greater than said second thrust, and said second thrust is greater than said first thrust,
(iii) subsequent to step (ii), implementing a third righting maneuver for a fourth time period, wherein for said fourth time period said first thrust, said second thrust and said third thrust are equal to one another
wherein the module executes a third tilt maneuver, wherein said first thrust is greater than said second thrust or said third thrust, and wherein said second thrust is greater than said third thrust, and, wherein said third tilt maneuver is configured to provide a desired change in azimuth during execution of said third tilt maneuver.

45. (canceled)

46. (canceled)

47. (canceled)

48. (canceled)

49. (canceled)

50. (canceled)
